(19) United States
(12) Patent Application Publication
(10) Pub. No.: US 2014/0317012 A1
(43) Pub. Date: Oct. 23, 2014

(54) ENABLING NON-MONETARY PHILANTHROPIC CURRENCY DONATION

(71) Applicant: Johnson & Johnson Services, Inc., New Brunswick, NJ (US)

(72) Inventors: Susan Can, Hoboken, NJ (US); John Berman, New York, NY (US); Nathaniel Drapiza, New York, NY (US); Cristen Ingram, New York, NY (US); Songul Aslanturk, New York, NY (US); Peter Kuang, New York, NY (US); Thomas Gilner, New York, NY (US); Danielle Frucci, New York, NY (US); Tiffany Tsoi, New York, NY (US)

(73) Assignee: Johnson & Johnson Services, Inc., New Brunswick, NJ (US)

(21) Appl. No.: 14/225,731

(22) Filed: Mar. 26, 2014

Related U.S. Application Data
(60) Provisional application No. 61/805,588, filed on Mar. 27, 2013.

(51) Int. Cl. G06Q 30/02

(52) U.S. Cl. CPC G06Q 30/0279
USPC 705/329

(57) ABSTRACT

A method of enabling philanthropic donation includes receiving from a user target data designating a donation target and item data corresponding to a non-monetary item. A processor automatically determines a currency amount of a monetary currency using the received item data and automatically produces a donation record indicating that the determined currency amount should be donated as specified by the designated donation target by a donating party different from the user. The donation can be verified and the user informed if the donation is not permitted. A system for enabling philanthropic donation includes the processor, a storage device storing target-menu data including indications of a plurality of donation targets, and a communications interface adapted to provide to the user at least some of the target-menu data and to receive the target and item data including social media functionalities for the user.

### CROSS REFERENCE TO RELATED APPLICATION

This application is based upon U.S. Ser. No. 61/805,588, filed on Mar. 27, 2013, the entire contents of which is incorporated by reference herein.

### TECHNICAL FIELD

The present application relates to methods and systems for enabling or processing philanthropic donations in which persons can access the Internet via a web portal in order to select a charitable cause from a menu of charitable causes and periodically donate a non-monetary item, such as a digital image or textual message. The item donation and charitable cause selection automatically triggers a monetary donation directed to the selected cause by a third party, such as a corporation.

### BACKGROUND

Numerous philanthropic, charitable, and non-profit organizations presently exist. These organizations are supported at least partly by donations, often from individuals. However, some forms of payment or other money transfer are not accepted by all organizations (e.g., debit-card transactions). Moreover, people who want to donate to multiple organizations are generally required to use one interface per organization. In some cases, this is as simple as mailing checks to each organization. However, even these mailings require keeping track of the organizations' addresses as well as physically preparing a check.

Donations are commonly accepted through the Internet and other computer networks. Many organizations have Web sites that accept credit-card information and process donation debits against the identified credit card. However, to donate to multiple organizations, people are sometimes required to create accounts, one per organization. The organizational burden of maintaining multiple accounts is well understood. While some systems, such as the Want2Donate.org Web site, provide directories to make it easier to find a charity, these systems do nothing to alleviate the burden of interacting with the selected charity.

Even if an organization does not require an account be created to make a donation, payment information must be transmitted over a network. The more often information is transmitted, and the more servers to which the information is transmitted, the more likely that a security breach will reveal that payment information to malicious third parties. There is a need, therefore, for a way of enabling users to make donations with reduced organizational burden and reduced security risk.

Some prior schemes have attempted to alleviate the organizational burden. The instead.com Web site and mobile app (downloadable smart-device application) permit users to select a recipient and donate money to instead.com, which then pays out the donation to the selected recipient. In this way, payment information is only held by instead.com and not by each recipient, and a person only needs to create one account to donate.

Other prior schemes involve redirecting money accrued by user activity to a philanthropic organization. U.S. Patent Publication No. 20100235245 to Grossman et al. describes a system in which publishers of Web sites earn revenue when users view advertisements displayed with their sites. Publishers can specify that revenue from certain advertisements, or from advertisements shown in certain advertisement placeholders, should go to a philanthropic organization rather than to the publisher. However, Web-site users viewing such advertisements are not giving of themselves or in any other way donating to the charity. In fact, users may not even know that a charity is being helped. The money going to the charity is not a donation, but rather money earned by the publisher for presenting the advertisements to the user. This scheme therefore does not provide users any of the intangible benefits of giving, and does not permit them any choice or involvement in the donation process.

Recently, it has been recognized that users' mindshare is also a valuable commodity. In addition to money, organizations benefit from publicity and word-of-mouth referrals. To assist the nonprofit WOUNDED WARRIOR PROJECT, in 2012, BANK OF AMERICA ran an online donation drive in which users could upload pictures and text messages thanking soldiers for their service. For each photo or message, the BANK OF AMERICA Charitable Foundation donated $1 to WOUNDED WARRIOR PROJECT. The drive had a maximum donation of $250,000. Similarly, in 2013, the United Nations Foundation ran an online donation drive called “Global Mom Relay.” This drive solicited donations, but also solicited sharing of a daily article posted online. When the article was shared by email or by posting on FACEBOOK or TWITTER, a corporate partner, such as JOHNSON & JOHNSON, would donate $5 to a selected charity, up to a daily maximum of $8,000. The campaign was four weeks long, and a different charity received the $5 donations each week.

It should be noted that the BANK OF AMERICA and United Nations Foundation drives deprive individuals of the opportunity to choose a charity. Individuals can choose to participate in such drives or not, but are not able to direct their contributions to causes about which they particularly care, or in which they are personally invested. Moreover, since these drives only relate to a limited number of charities, they do not alleviate the organizational burden of supporting multiple charities. Furthermore, these campaigns are hosted on specific Web sites that a user must visit in order to donate, which adds logistical steps that must be performed to donate.

There is, therefore, a continuing need for a way of permitting individuals to donate to charities of their choice with reduced organizational burden and fewer logistical requirements. There is also a previously-unrecognized need to combine donations of money and donations of mindshare in a way that integrates with users' lives. A problem not solved by prior schemes is that of finding a way of integrating actions users already perform with charitable giving. Another problem not solved by prior schemes is the problem of performing this integration in a way that enables users to be involved in the donation process and provides them an opportunity to contribute to particular areas about which they are concerned.

The discussion above is merely provided for general background information and is not intended to be used as an aid in determining the scope of the claimed subject matter.

### BRIEF DESCRIPTION OF THE INVENTION

In accordance with an aspect of the present invention, there is provided a method of enabling philanthropic donation, the method comprising the steps of receiving from a user target data designating a donation target as well as item data corresponding to a non-monetary item. Using a processor, a currency amount of a monetary currency is automatically determined; and using the processor, a donation record is automatically produced indicating that the determined currency amount should be donated as specified by the designated donation target by a donating party different from the user.

In accordance with another aspect of the present invention, there is provided a method of enabling philanthropic donation. According to the method, target-menu data is provided to a user, including indications of a plurality of donation targets. The user then designates one of the donation targets indicated in the target-menu data which is received as target data. Item data is received from the user, corresponding to a non-monetary item. Using a processor, a currency amount of a monetary currency is automatically determined using the received item data. A donation record is automatically produced using the processor indicating that the determined currency amount should be donated as specified by the designated donation target by a donating party different from the user.

In accordance with another aspect of the present invention, there is provided a system for enabling philanthropic donation. A storage device stores target-menu data including indications of a plurality of donation targets. A communications interface provides at least some of the target-menu data. A user provides target data designating one of the targets indicated in the target-menu data to the communications interface. The communications interface also receives from the user item data corresponding to a non-monetary item. A processor automatically determines a currency amount of a monetary currency using the received item data. The processor also produces a donation record indicating that the determined currency amount should be donated as specified by the designated target by a donating party different from the user.

In accordance with another aspect of the present invention, there is provided a method of enabling philanthropic donation by a user. According to the method, user data identifying the user is received. Item data corresponding to a non-monetary item is received from the identified user. A processor is used to automatically determine whether a donation of the non-monetary item is permitted. If the donation is permitted, using the processor, a currency amount of a monetary currency is automatically determined using the received item data. A donation record is produced indicating that the determined currency amount should be donated by a donating party different from the identified user. An indication that the item data was received is stored in a log associated with the identified user. If the donation is not permitted, an indication that the donation is not permitted is automatically transmitting to the identified user. In order to determine whether the donation is permitted, the log associated with the identified user is automatically analyzed.

In at least one version, the selection of the various charitable causes and non-monetary items submitted using the methods and systems described can be functionally linked into various social media systems. For example, donated photographs or textual messages and causes can be additionally shared using social media based websites such as FACEBOOK, TWITTER and/or INSTAGRAM through features such as those provided on an interface available to the user(s).

An advantage that may be realized in the practice of some disclosed embodiments of the methods and systems described herein is that users can make non-monetary donations of non-monetary items they produce or encounter in their daily lives. Users can readily integrate such donations into their lives. Various aspects permit users to select a charity or other donation target to receive the benefit of their donation. Various aspects remove from users logistical burdens related to monetary transactions, permitting users to donate more readily. Various aspects provide display records, e.g., on social-networking sites, and record data, e.g., in image galleries, with which users can donate mindshare as well as non-monetary items. Various aspects permit users to interact with a variety of charities without having to create separate accounts for each charity. Various aspects of donation-enabling systems receive no money from users, so there is no risk that a user's financial information will be compromised by virtue of the user's normal interaction with the donation-enabling system. Various embodiments permit donation without writing a paper check.

This brief description of the invention is intended only to provide a brief overview of subject matter disclosed herein according to one or more illustrative embodiments, and does not serve as a guide to interpreting the claims or to define or limit the scope of the invention, which is defined only by the appended claims. This brief description is provided to introduce an illustrative selection of concepts in a simplified form that are further described below in the detailed description. This brief description is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

So that the manner in which the features of the invention can be understood, a detailed description of the invention may be had by reference to certain embodiments, some of which are illustrated in the accompanying drawings. It is to be noted, however, that the drawings illustrate only certain embodiments of this invention and are therefore not to be considered limiting of its scope, for the scope of the invention encompasses other equally effective embodiments. The drawings are not necessarily to scale, emphasis generally being placed upon illustrating the features of certain embodiments of the invention. In the drawings, like numerals are used to indicate like parts throughout the various views. For further understanding of the invention, reference can be made to the following detailed description, read in connection with the drawings in which:

FIG. 1 is a dataflow diagram of a method and a system of enabling philanthropic donation according to various aspects;

FIG. 2 shows relationships between terms used in this application;

FIGS. 3-8 are flowcharts illustrating exemplary methods for enabling philanthropic donation;

FIG. 9 shows an exemplary system for enabling philanthropic donation and related components;

FIG. 10 is a flowchart illustrating exemplary methods for enabling philanthropic donation.

FIG. 11 is a high-level diagram showing the components of a data-processing system; and

FIGS. 12-26 are representations of screen captures of a mobile app designed to interact with systems for enabling philanthropic donation according to various aspects.

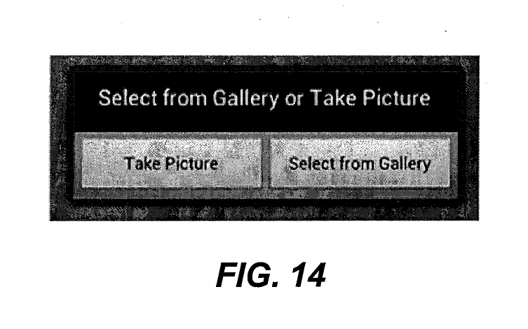

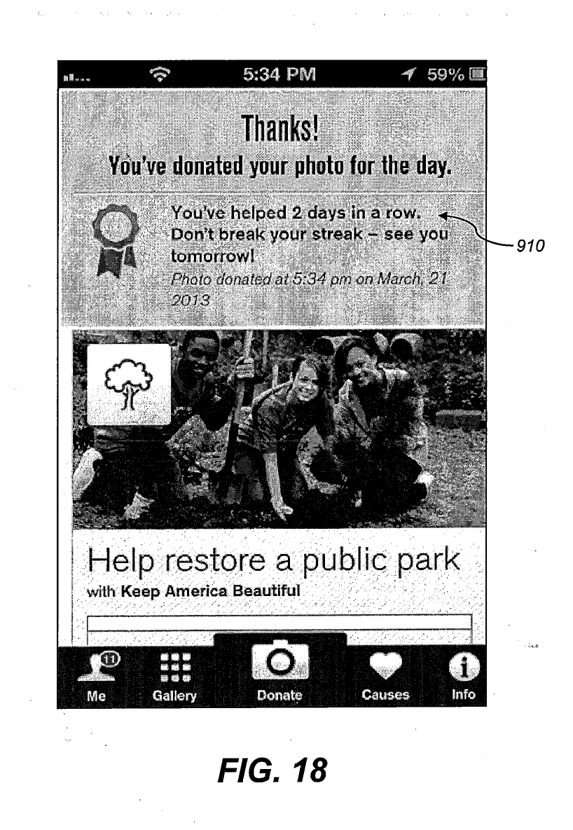

The attached drawings are for purposes of illustration and are not necessarily to scale, in each dimension individually or in any set of dimensions together. The word marks “SAVE THE CHILDREN,” “SAFE KIDS WORLDWIDE,” and “KEEP AMERICA BEAUTIFUL” in FIGS. 13, 18, 25, and 26, and “FACEBOOK” and “TWITTER” in FIG. 17, are registered trademarks of, respectively, Save The Children Federation, Inc.; Safe Kids Worldwide Corporation; Keep America Beautiful, Inc.; Facebook, Inc.; and Twitter, Inc. The scope of the claims in this application is not limited to systems or methods provided by, or embodied in products or services of, such parties. The scope is also not limited to systems or methods interacting with such products or services or such parties. No such limitation should be inferred.

### DETAILED DESCRIPTION OF THE INVENTION

The following description relates to exemplary embodiments of systems and methods of enabling philanthropic donation as well as use thereof in allocating or otherwise specifying the donation of monetary currency by a donating party in response to non-monetary donations by users. In order to provide a suitable frame of reference with regard to the accompanying drawings, certain terms are used throughout. These terms are not intended to narrow the scope of the concepts detailed herein, including those embodied in the claims, unless specifically indicated. In addition and in the following description, some aspects will be described in terms that would ordinarily be implemented as software programs. Those skilled in the art will readily recognize that the equivalent of such software can also be constructed in hardware (hard-wired or programmable), firmware, or micro-code. Accordingly, aspects of the present invention may take the form of an entirely hardware embodiment, an entirely software embodiment (including firmware, resident software, or micro-code), or an embodiment combining software and hardware aspects. Software, hardware, and combinations can all generally be referred to herein as a “service,” “circuit,” “circuitry,” “module,” or “system.” Various aspects can be embodied as systems, methods, or computer program products. Because data manipulation algorithms and systems are well known, the present description will be directed in particular to algorithms and systems forming part of, or cooperating more directly with, systems and methods described herein. Other aspects of such algorithms and systems, and hardware or software for producing and otherwise processing signals or data involved therewith, not specifically shown or described herein, are selected from such systems, algorithms, components, and elements known in the art. Given the systems and methods as described herein, software not specifically shown, suggested, or described herein that is useful for implementation of any aspect is conventional and within the ordinary skill in such arts.

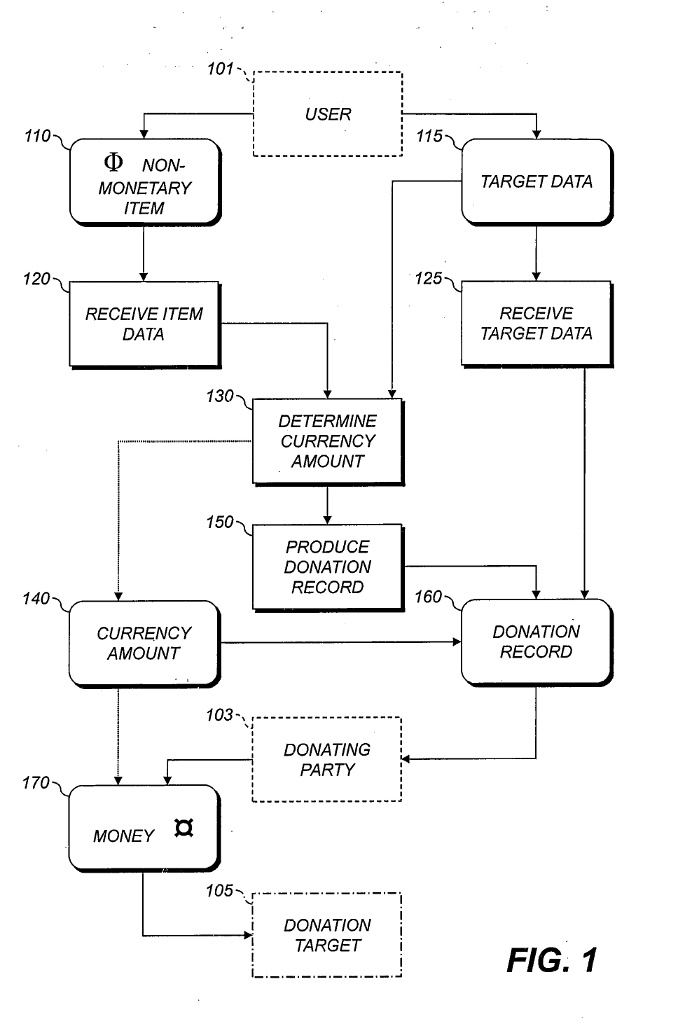

FIG. 1 is a dataflow diagram of an exemplary method of enabling philanthropic donation. As shown, rectangles represent processing elements performing the indicated steps, rounded rectangles represent data items, and dashed rectangles represent parties involved in the donation. Other divisions of elements and data between the parties can also be used as described herein. For purposes of this application, the term “processing elements” refers to elements including a processor, part of a processor, or part of a program for a processor.

Generically, a user 101, who can be a natural or legal person, provides item data 110 corresponding to a non-monetary item. The non-monetary item is a unit of non-monetary philanthropic currency (NMPC, herein designated “Φ,” for “philanthropy”). One unit of NMPC is designated “Φ1”. Processing element 120 receives the item data, e.g., via a network connection. Processing element 130 automatically determines a currency amount 140 (e.g., $1) of a monetary currency (e.g., U.S. dollars) using the received item data. Herein, amounts of money or monetary currency are designated using the generic currency symbol “ [symbol] ”, e.g., [symbol] 1 for one unit of money, of whatever currency.

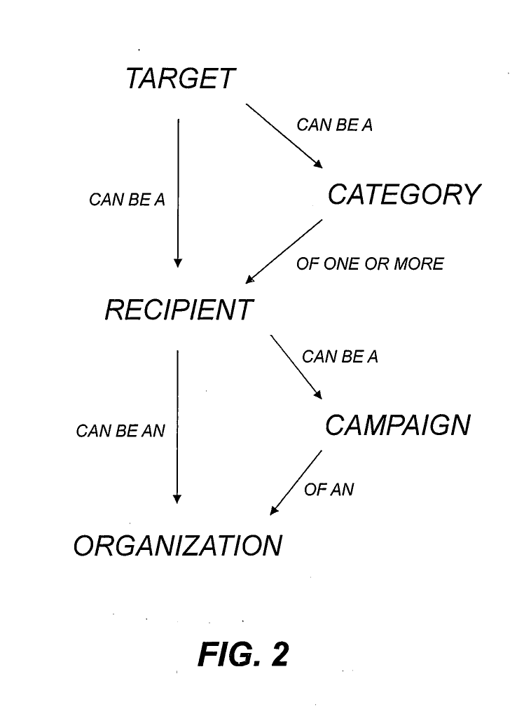

The user 101 can also provide target data 115 designating a donation target 105. Processing element 125, e.g., a user or network interface, receives the target data. The donation target 105 can be a party (e.g., person or organization), or a category, as discussed below with reference to FIG. 2. Target data 115 can also be used in determining the currency amount (processing element 130), as discussed below.

Processing element 150 automatically produces a donation record 160 indicating that the determined currency amount (or an equivalent amount of the monetary currency or another monetary currency) should (or will) be donated philanthropically by a donating party 103 different from the user 101. The donating party 103 can be a natural or legal person or organization, and can operate or pay for operation of a server including processing elements 130 and 150. The donating party 103 can, in response to the donation record 160, donate money 170 in the determined currency amount 140 (as indicated by the dotted arrows) to the specified donation target 105.

FIG. 2 shows relationships between terms used in this application. The term “philanthropic donation” as used herein refers to provision of a non-monetary item by a user, such as a photograph or textual message, when that provision is intended to directly benefit someone other than the user. The user can also benefit, e.g., from local tree-planting efforts. The term “philanthropic donation” also includes such provision made to an organization recognized as a non-commercial organization. As used herein, a “target” specifies, at some level of detail, what area of human endeavor a user wants to benefit with a donation, e.g., a non-monetary donation. A target can be a “recipient” or a “category” of recipients. If the target is a category, the user's intent is that the donation will benefit some recipient in that category. A “category” can include recipients that are related or similar in various ways. Examples of categories can include: recipients working in a particular country or other geographical area; recipients working to benefit particular segments of the population (e.g., children or the elderly); recipients headquartered in a particular country or area; recipients that generally provide the same types of services (e.g., food pantries or soup kitchens); recipients that share common ideological traits, characteristics or orientations (e.g., charitable organizations run by a particular denomination or other geographically-dispersed religious group, or committees to elect candidates of a particular political party to various offices); and recipients that have a particular legal status (e.g., recipients for which donations thereto are tax-deductible).

As used herein, the term “recipient” can refer to an “organization,” which term, as used herein, includes individuals acting on their own behalf, associations of individuals, societies, corporations, non-profit or charitable organizations such as 501(c)(3) bodies in the US or registered charities in the UK, churches or other religious organizations, or other bodies serving charitable, nonprofit, or humanitarian purposes, or other purposes the user deems worthy of donations. An “organization” can also be a non-profit advocacy organization, e.g., a political action committee or candidate's election fund, or a for-profit organization provided the user intends to derive no personal benefit from the donation. A “recipient” (and thus a “target”) can also be a particular activity, campaign, initiative, or program performed, operated, supervised, controlled, or otherwise directed or carried out by an organization (as defined above).

In a specific illustrative example, the target is WORLD VISION International, a humanitarian organization providing food, clean water, and other improvements to quality of life to children and their families in impoverished areas around the world. This target is a recipient and is also an organization. In another illustrative example, the target is the sponsorship of a particular child through WORLD VISION. This target is a recipient, which is a campaign (the sponsorship of a child) carried out by an organization (World Vision).

In yet another illustrative example, the target is the category of residential-area beautification. A user wanting to support recipients that help keep residential areas in pleasing appearance would be willing to support either KEEP AMERICA BEAUTIFUL or the ARBOR DAY FOUNDATION, either of which would be a recipient. A specific program, e.g., distributing trees to plant on Arbor Day, is a campaign that can also be a recipient in the category of residential-area beautification.

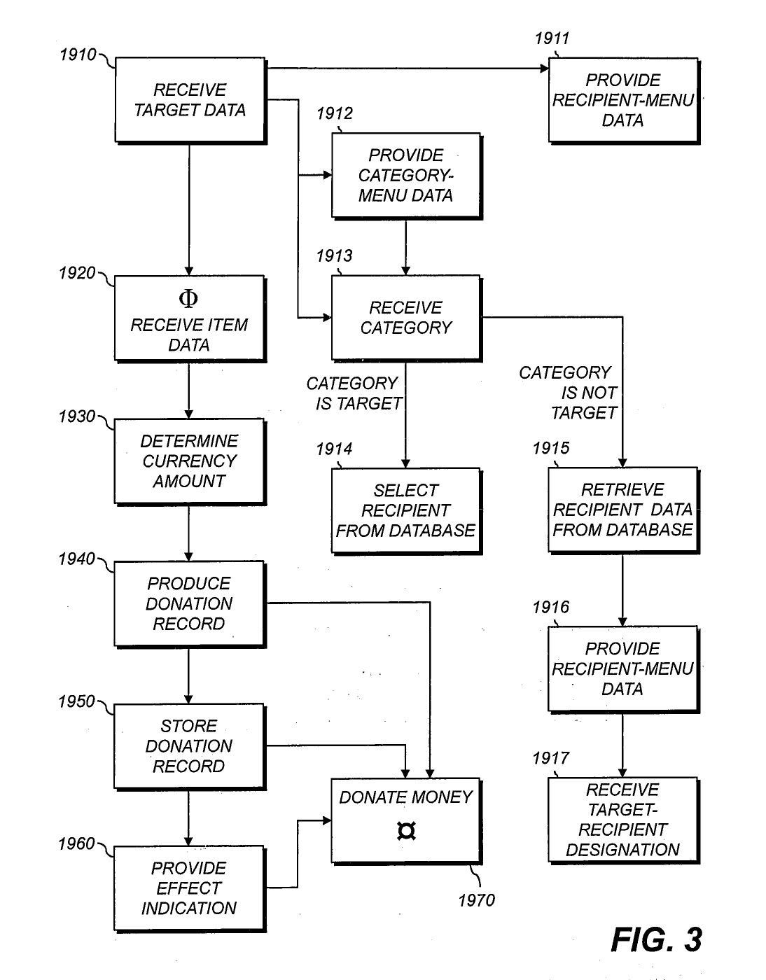

FIG. 3 is a flowchart illustrating exemplary methods for enabling philanthropic donation. Philanthropic donation and the examples of donation targets are discussed above with reference to FIG. 2. The steps described herein can be performed by a processor controlled by the donating party 103, or by another party. In this and other flowcharts herein, the order of steps is not constrained except as explicitly set forth in the claims. Processing begins with step 1910.

In step 1910, target data is received from a user, e.g., via the user's terminal, such as, a mobile device which could include a smartphone or a tablet PC, for example. The target data designates a donation target, e.g., a category or a recipient, as discussed above. The user or terminal can be located in a specific country or geographical area, or anywhere in the world, or in space, or any combination. In various aspects, step 1910 includes rejecting target data received from a user determined to be outside an area from users in which donations are accepted, such determination made using, e.g., IP-address geolocation.

In step 1920, item data is received from the user, e.g., via the terminal, such as a mobile device. The item data corresponds to a non-monetary item, i.e., an item of non-monetary philanthropic currency “Φ.” For example, the non-monetary item can be a photograph and the item data the digital image file of that photograph. Throughout this disclosure, the terms “item data” and “non-monetary item” are used interchangeably unless explicitly differentiated. Therefore, “receiving a non-monetary item” is a more concise reference to an activity or step of “receiving item data corresponding to a non-monetary item.” In various aspects, the donating party receives the item data. In various aspects, the item data includes a textual message, e.g., a message in a natural, human language (e.g., English, German, or Japanese) or a computer programming language (e.g., C, FORTRAN, COBOL, or Pascal). The message can be related to the designated donation target, or not. The image data can include both a message and image data.

In step 1930, using a processor, a currency amount (e.g., $1) of a monetary currency (e.g., U.S. Dollars) is automatically determined using the received item data. “Using the received item data” can include using the simple fact that the item data was received. The currency amount can be a fixed amount for each receipt of item data; for example, the processor can automatically retrieve a selected currency amount from a memory in response to the receipt of the item data. Alternatively, the currency amount can vary based on, e.g., the content of the item data or the frequency with which item data is received from the user. For example, the processor can check if the item data is a picture larger than a certain size (e.g., 1×1 pixels) and determine the amount is [symbol] 0 if not and a selected positive amount if so. The controller can also skip producing-donation-record step 1940 if the amount is [symbol] 0.

In step 1940, using the processor, a donation record is automatically produced. The donation record indicates that the determined currency amount of the monetary currency, or an equivalent amount of the monetary currency or another currency, should or will be donated as specified by the designated donation target by a donating party different from the user. For example, if the donation target is an organization, the donation record can be produced to indicate that the money should be donated to the organization.

In various aspects, step 1950 includes storing the produced donation record on a non-transitory computer-readable medium. The produced donation record includes data indicating the determined currency amount and data indicating the designated donation target.

In various aspects, the donation target is a particular campaign of an organization, as discussed above, and the campaign specifies an effect of donating the non-monetary item. In step 1960, an indication of the specified effect is provided to the user. The indication can be data transmitted to the user, e.g., to the user's terminal. Step 1960 can be performed before or after receiving-item-data step 1920, and before or after producing-donation-record step 1940. In an example, before step 1920, a message is transmitted to the user suggesting that the user donate a non-monetary item to obtain a desired effect, e.g., “donate a photo to plant 10 trees.” In another example, after step 1920 or 1940, a message is transmitted to the user indicating the effect, e.g., “this photo planted 10 trees.” In an example, the campaign specifies that the effect of donating the non-monetary item is that the donation target provides a usable item (e.g., a good, an object, an item of value, or a health-care item that can be used for a desired purpose) to a person in need. The message after step 1940 can then indicate, e.g., “this photo bought a mosquito net for a child in Africa.”

In various aspects, step 1970 follows step 1940, 1950, or 1960. In step 1970, the donating party donates the determined currency amount (“ [symbol] ”) as specified by the designated donation target and in response to the donation record. Such monetary donations can be made directly upon production of the donation record or later, and can be batched to occur in intervals, e.g., daily, weekly, monthly, quarterly, or annually. The size of a batch can be selected as desired. In various aspects, the donating party is a corporation.

In various aspects, step 1910 includes step 1911. In step 1911, recipient-menu data are provided, e.g., to the user via the terminal. The recipient-menu data include indications of a plurality of donation recipients. The received target data then designates as the donation target one of the donation recipients indicated in the recipient-menu data. For example, the menu can specify “WORLD VISION International,” the “ARBOR DAY FOUNDATION,” and “SAVE THE CHILDREN,” and the user can provide (and the system receive) target data designating one of those donation recipients as the donation target.

In various aspects, step 1910 includes steps 1913 and 1914. In step 1913, the target data are received that designate a category of donation recipients. For example, the target data can designate one of “Help a newborn thrive,” “Help protect a child from a sports injury,” or “Help restore a public park” (see, e.g., FIG. 13). In step 1914, the processor automatically retrieves from a database a selection of a donation recipient in the designated category (e.g., “SAVE THE CHILDREN,” “SAFE KIDS WORLDWIDE,” or “KEEP AMERICA BEAUTIFUL,” respectively). As used herein, a “database” is any organized data storage system, hardware or software, that permits locating data having or associated with specific attributes. Examples include relational databases that can be queried with SQL or other query languages; nonrelational databases such as NoSQL; key-value stores; XML or other hierarchical data stores; flat files and directories (e.g., as used in the “tz” time-zone software package); or other data storage systems, local, remote, distributed, striped, or otherwise.

In these aspects, in step 1940, the processor automatically provides a recipient indication of the selected donation recipient in the produced donation record. The donation record thus indicates that the determined currency amount should be donated to the selected donation recipient. A donation to the selected donation recipient is a donation made as specified by the designated donation target, i.e., the target indicated in the received target data, since the recipient in the designated category. In this way, users can select a general area of activity in which they want to make a contribution. The donating party or other operator of a donation-enabling system can determine which recipient(s) are appropriate for a given category. This relieves the user of the burden of maintaining relationships with multiple organizations.

In some of these aspects, step 1910 also includes step 1912. In step 1912, category-menu data are provided to the user, e.g., by the processor via the terminal. The category-menu data include indications of a plurality of recipient categories, e.g., those discussed herein with reference to step 1913. Step 1913 thus includes receiving the target data designating one of the recipient categories indicated in the category-menu data as the donation recipient.

In various aspects, step 1910 includes step 1912 of providing to the user category-menu data including indications of a plurality of recipient categories, and step 1913 of receiving from the user category data designating one of the recipient categories indicated in the category-menu data. In these aspects, the category data is not the target data. In step 1915, the processor automatically retrieves from a database respective recipient data for a plurality of donation recipients corresponding to the designated category.

In step 1916, using the retrieved recipient data, the processor provides to the user recipient-menu data including indications of the plurality of donation recipients. The recipient-menu can be provided exactly as retrieved from the database (e.g., an XML menu to be formatted by a stylesheet on the user's terminal) or can be formatted before provision to the user.

In step 1917, the target data are received. The target data designate one of the donation recipients indicated in the recipient-menu data as the donation target. This permits the user to readily locate specific organizations to support based on their categories, and still reduces the organizational burden to the user by offloading the mechanics of the donation onto the donating party.

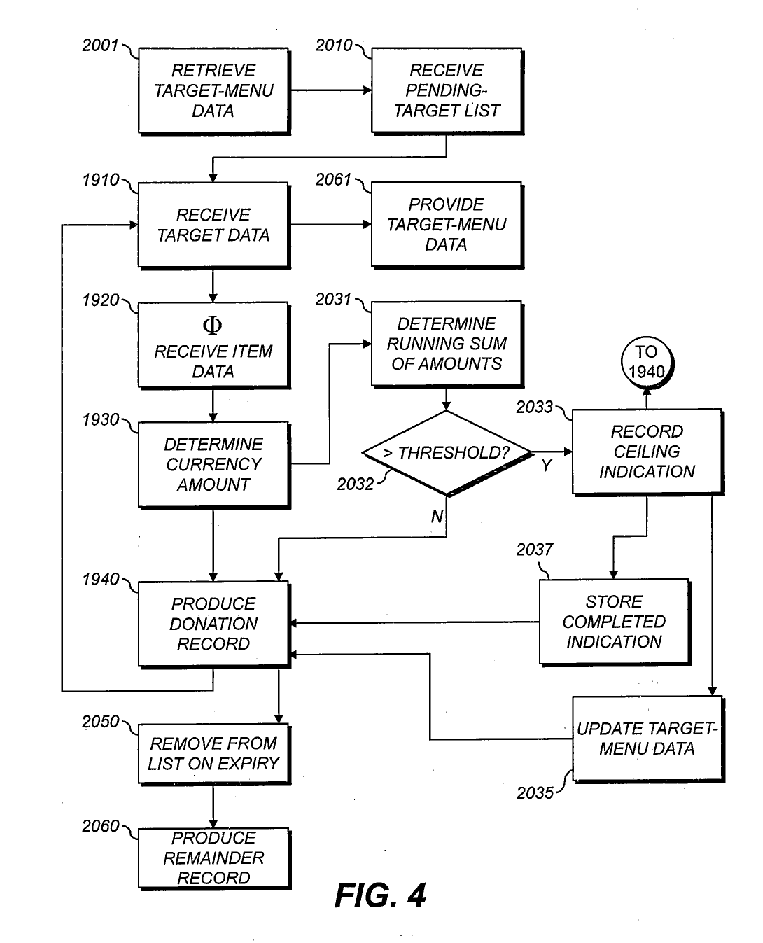

FIG. 4 is a flowchart illustrating exemplary methods for enabling philanthropic donation. In various embodiments, sums of currency amounts designated for each donation target are tracked. Specifically, the receiving-designation step 1910, receiving-item-data step 1920, determining step 1930, and producing step 1940 are repeated for each of a plurality of non-monetary items, each with respective received item data. All of the non-monetary items can be for one donation target, or some of the items for each of any number of donation targets.

For each received non-monetary item, in step 2031, the processor determines a sum of the determined currency amount(s) indicated in the produced donation record(s) for the designated donation target. Decision step 2032 determines whether the sum exceeds a selected upper threshold. If so, the next step is step 2033. If not, the next step is a producing-record step 1940.

In step 2033, the processor automatically records a ceiling indication that the designated donation target is no longer open for donations. That is, donation records will no longer be produced that specify a currency amount greater than [symbol] 0 for the designated donation target. This does not imply that non-monetary donations will no longer be accepted by the system, the target, or other components. The donation that pushes the sum over the limit can be accepted and a record produced (step 1940), or not. If not, the next step is step 1910.

In some embodiments, before step 1910, target-menu data is retrieved from a storage device (step 2001). The target-menu data includes indications of a plurality of donation targets. In step 2010, a list of pending-target indications is received. Each pending-target indication indicates a donation target. The donation targets listed in the target-menu data can be omitted from the pending-target indication list.

In these embodiments, receiving-target step 1910 includes step 2061. In step 2061, the target-menu data is provided to the user and the target data designating one of the targets indicated in the target-menu data is received from the user. In response to the recording of the ceiling indication for a first one of the target(s) indicated in the target-menu data (step 2033), step 2035 is performed. In step 2035, the target-menu data is updated by removing the indication of the first one of the target(s) from the target-menu data (herein, “removing a target from the menu” signifies “removing the indication of the target from the menu data”). According to step 2035, the processor also automatically selects a replacement target from the targets indicated on the received pending-target indication list, and adds an indication of the selected replacement target to the target-menu data. In this way, as donation targets are removed from the target-menu data, new donation targets are added.

In various of these embodiments, the replacement donation target is selected from the same category as the first one of the target(s). Some categories can be ongoing, replenished with recipients in the same category. Some categories can be transient, only present until one recipient has reached a monetary total above the threshold. For the former, each target indication in the target-menu data and the pending-target indication list indicates a donation recipient associated with at least one of a plurality of categories. The selecting-replacement-target step 2035 includes automatically selecting the replacement target from the donation target(s) indicated on the received pending-target indication list that are associated with the same category as the first donation target.

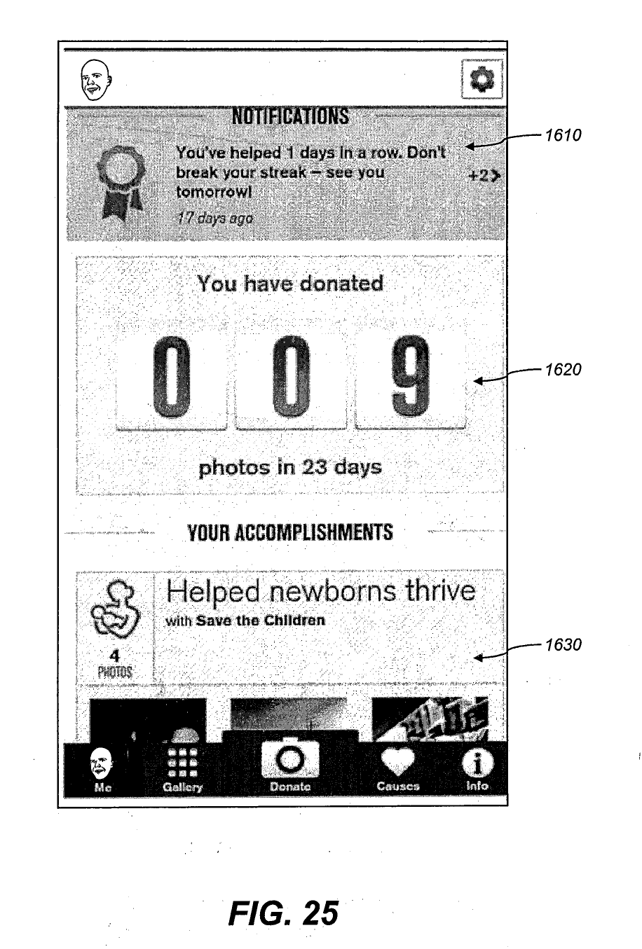

In various aspects, step 2033 is followed by step 2037. In step 2037 and in response to the removal of one of the targets from the target-menu data, an indication of that target is stored in a completed-target list stored on a storage device. An example of a visual representation of a completed-target list is discussed herein with reference to list 1530, FIG. 24. This representation advantageously provides users an opportunity to remember how they have contributed and to derive corresponding feelings of well-being. This also provides an opportunity for users to encourage others to give by showing those others the community of donors.

In various aspects, in step 2050, a donation target that has been included in the target-menu data for more than a selected time period, e.g., one month, is automatically removed from the target-menu data. Other criteria can be used to determine when a donation target has expired and should be removed. For example, fewer than n donations in m days can trigger expiration. In some of these aspects, a donation record is automatically produced specifying that an amount equal to the difference between a selected lower threshold and the sum of the determined currency amount(s) should be donated as specified by the designated donation target by the donating party. In this way, at least a minimum amount is donated to each donation target.

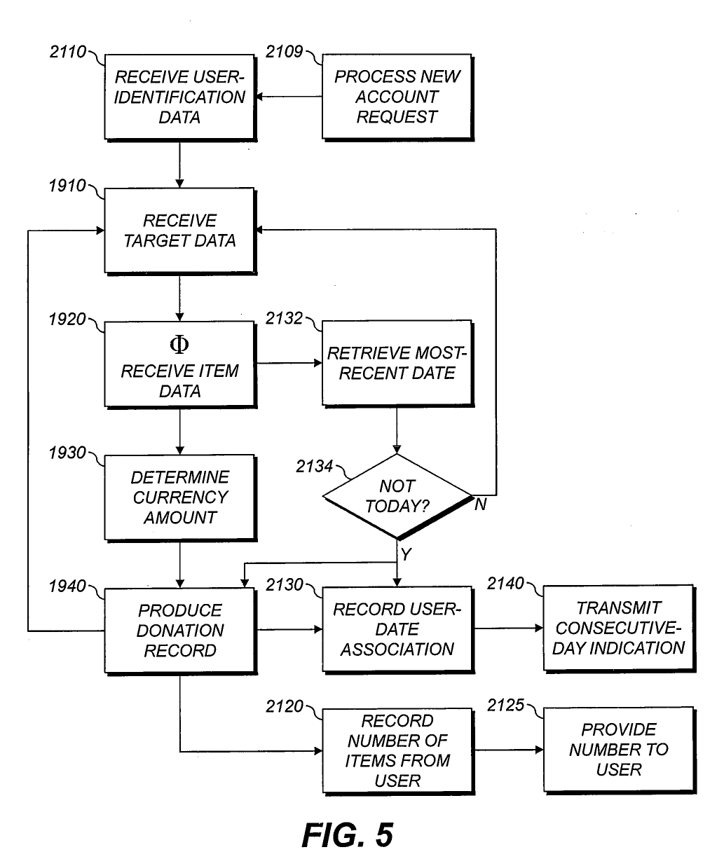

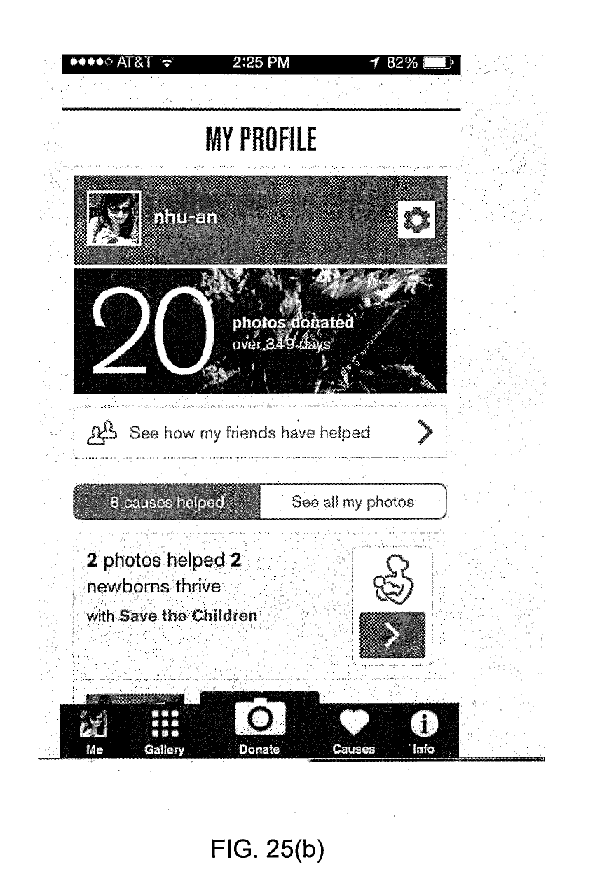

FIG. 5 is a flowchart illustrating exemplary methods for enabling philanthropic donation. In step 2110, data indicating an identification of the user is received from the user's terminal. In step 2120, the number of non-monetary items that are received from the user is recorded. For example, a stored counter can be incremented with each item received (see, e.g., text 1620 in FIG. 25). In step 2125, the recorded number of items is provided to the user.

In step 2130, an association is recorded between the user and a date on which the non-monetary item is received. In various aspects, the receiving-item-data step 1920 and the determining-amount step 1930 are repeated for each of a plurality of non-monetary items, each with respective received item data. For each received item, in step 2132, the most recent date of a recorded association is retrieved. According to decision step 2134, the processor determines whether the retrieved date is different from a date of receipt of the received item. If so, the next step is step 1940, and step 2130 can also be performed. If not, the association is not recorded and the donation record is not produced, so the next step is step 1910 (shown) or step 1920. In this way, only a single donation per day is accepted. This limit can be applied to the user regardless of donation target, or to each donation target (one per day per target).

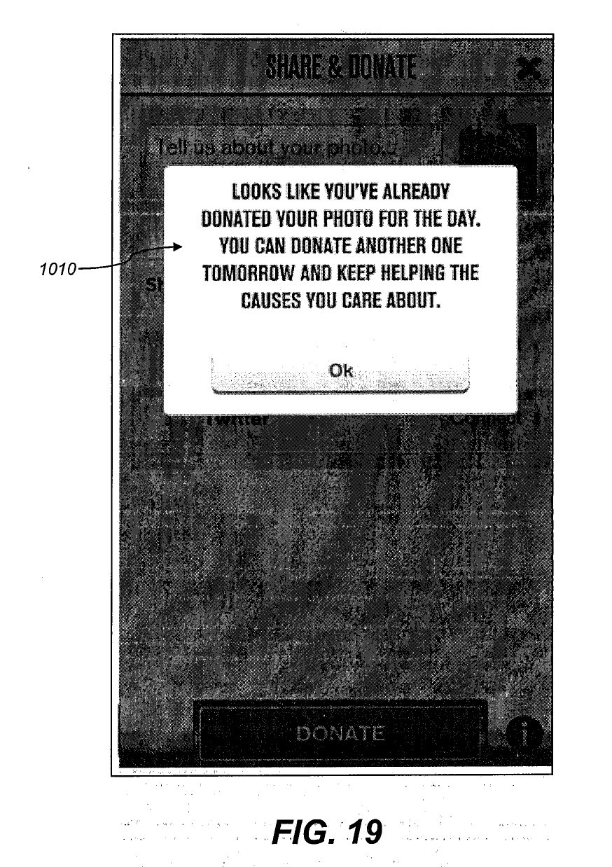

In step 2140, the controller determines, for an item for which an association is recorded, whether the recorded association(s), if any, include a period of consecutive dates including the date of receipt of that item. If so, the controller transmits data indicating the number of dates in the period to the user (e.g., text 910, FIG. 18).

In various aspects and before receive-user-identification step 2110, in step 2109, a new-account request is processed. Using a terminal, Web browser, or other electronic communications device or channel, the user can communicate a desired username and password (or other credential information), and optionally further provide information such as name, avatar image, e-mail address, or location. Using a processor, the received information is automatically validated, e.g., to see that the desired username is not already in use. If the information is valid, it is stored. For example, a secure hash such as a SHA-1 hash with cryptographic salt, and the salt itself, can be stored in a database or disk file. Subsequently, when user-identification data are received in step 2110, this data can be compared to or verified against the stored user-identification data. Continuing the example above, the received user-identification data include a username and password. The stored salt for the username is retrieved from the database or disk file, and the salt is hashed with the received password. If the resulting hash matches the hash in the database, the password is correct and the user can proceed. In step 2110, if user-identification data do not match the stored information, a “login failure” message such as “bad username or password” can be provided to the user.

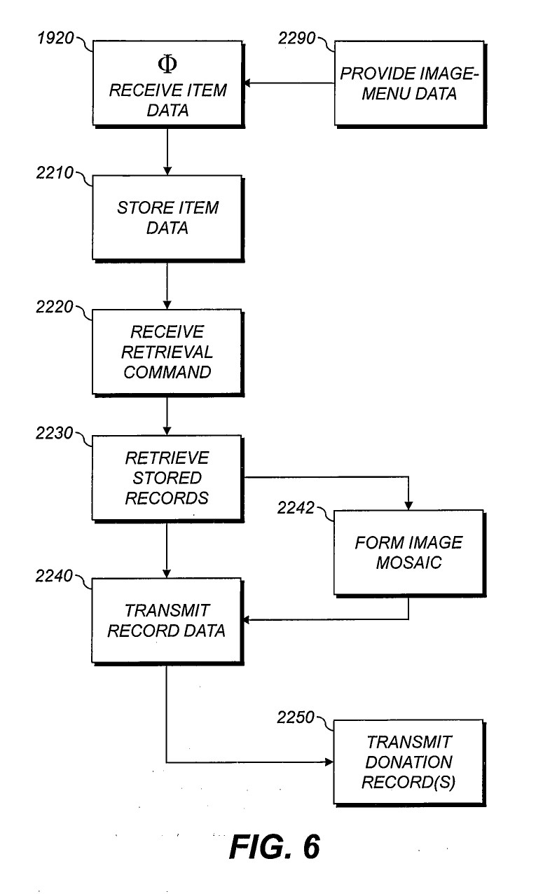

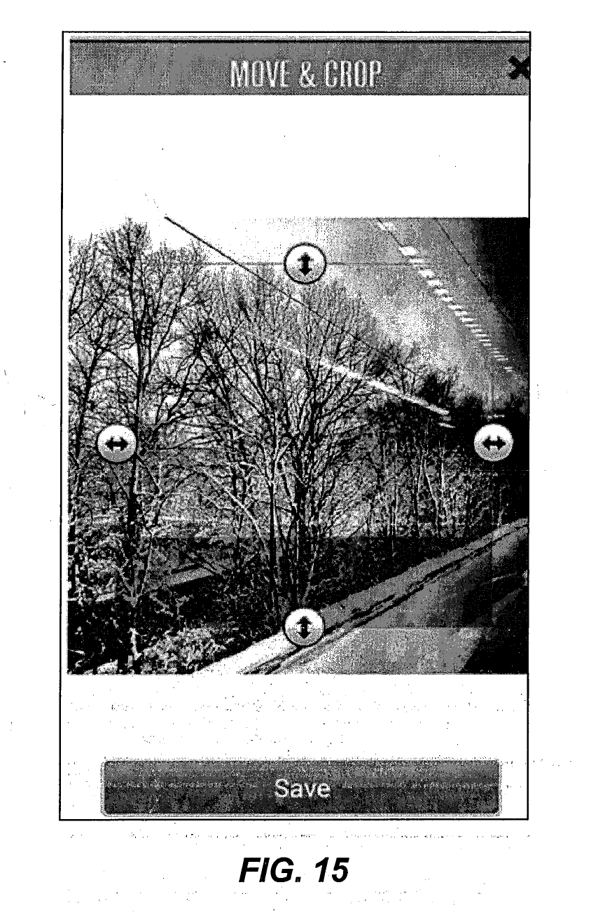

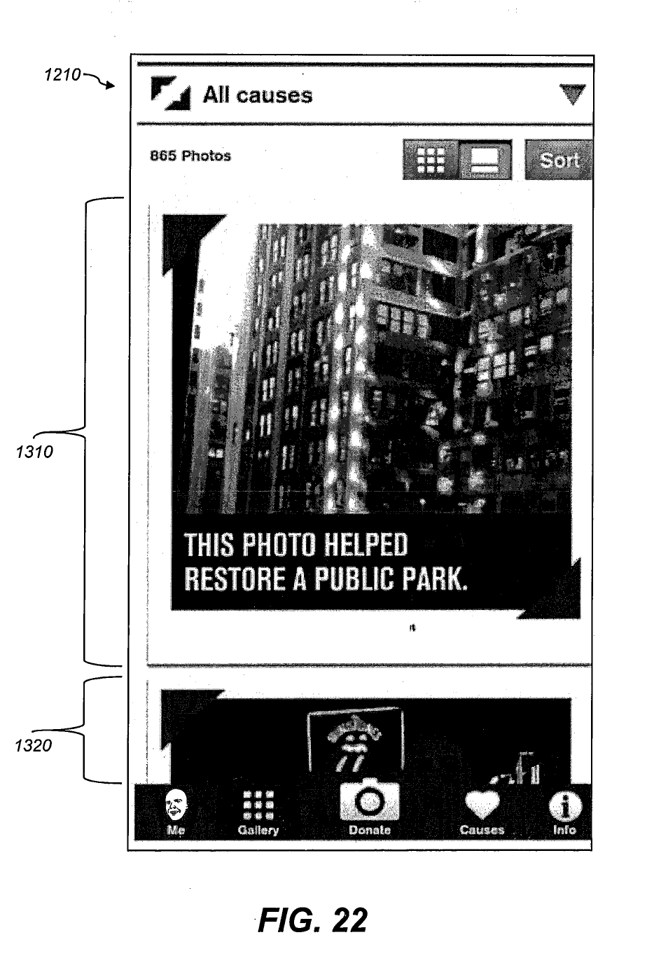

FIG. 6 is a flowchart illustrating exemplary methods for enabling philanthropic donation. In various aspects, an image or other item-data gallery is provided. Examples of how item-data galleries appear to users are shown herein with reference to FIGS. 21-24. The gallery can show all item data, or only that for certain targets or recipients which can be shared using social media according to at least one version as described herein. Other data can also be stored, e.g., by the processor, and provided for all targets or per-target. In step 2210, the received item data is stored in an item-data record associated with the designated donation target. The item data can include an image, either newly-captured or previously-captured, FIG. 14); a sponsor's or other corporate logo or icon, a sponsor's or other product logo or icon; a message provided by the user; or any combination thereof.

In step 2220, a command is received to retrieve item data. The command includes data indicating one or more donation target(s) (which can include data indicating that all donation target(s) known to the system should be selected, or all active, or all on the completed list; targets can be, but are not required to be, enumerated individually). The command can be retrieved from the user or from another entity. The command can be received from a terminal, a Web browser, or another electronic communications tool. The command can be received via a communications network such as a cellular network or a network implementing the IP protocol over Ethernet, Token Ring, FDDI, or other data links.

In step 2230, one or more stored item-data record(s) associated with the indicated donation target(s) are retrieved.

In step 2240, record data of the retrieved item-data record(s) are transmitted, e.g., to the requesting entity. The record data can be extracted verbatim from the retrieved item-data record(s) or can be transformed. In various aspects, content moderation filters can be used to modify or redact the retrieved item-data record(s) to form the record data. For example, if a given item-data record includes an image that was previously transmitted in response to a retrieval command, and a flag indication was received from the entity receiving the corresponding record data, that item-data record can be withheld from record-data transmissions until a human or automated moderator has reviewed the image data in that item-data record for conformance to decency or other selected criteria.

In various aspects, step 2250 includes transmitting some or all of the donation record(s) associated with the indicated donation target(s).

In various aspects, the record data includes a digital image, still or motion, or a textual message. In various aspects, the record data includes a representation (visual, auditory, or olfactory) of a mark used in trade. Examples of such representations include corporate logos and product icons. The mark used in trade can be a registered trademark, or not.

In various aspects, in step 2242, a mosaic image is formed using image data of the retrieved item-data record(s). Image data of the mosaic image are transmitted as the record data.

In various examples, the item data includes a digital image, still or motion, from a camera roll or freshly captured. In step 2290, image-menu data are provided to the user. The image-menu data can include a plurality of digital images. The item data Φ received in step 1920 thus includes image data of, or an indication of, one of the digital images in the image menu data. In an example of an indication, the image-menu data can include thumbnails with serial numbers, and the received item data can be the serial number of the desired image. Examples of images in the image-menu data include pictures of consumer products or logos, and pictures related to an available donation target.

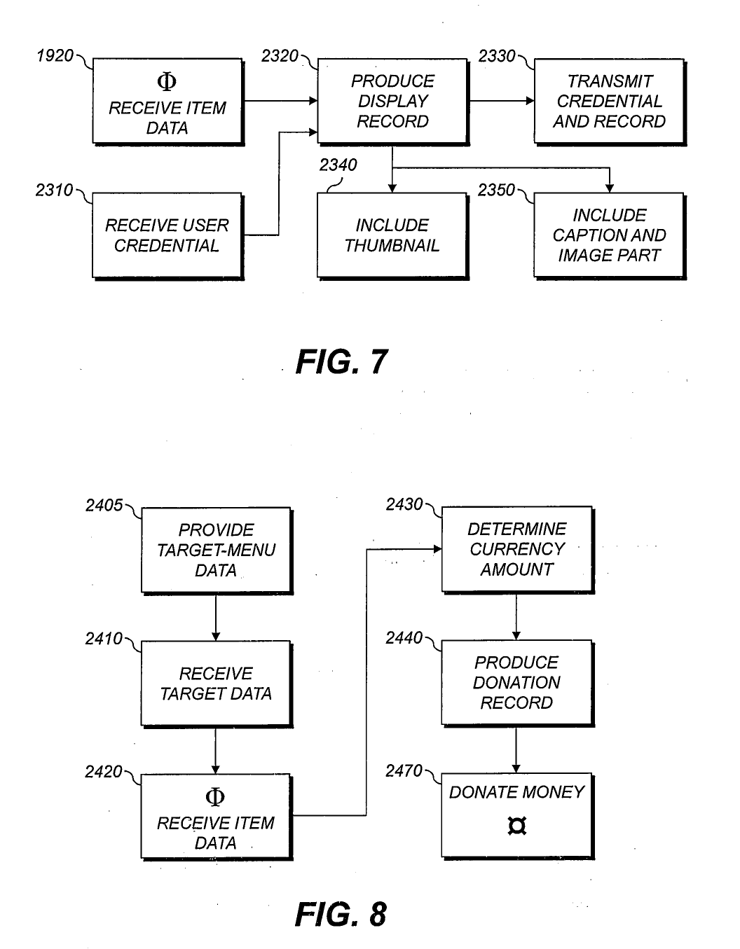

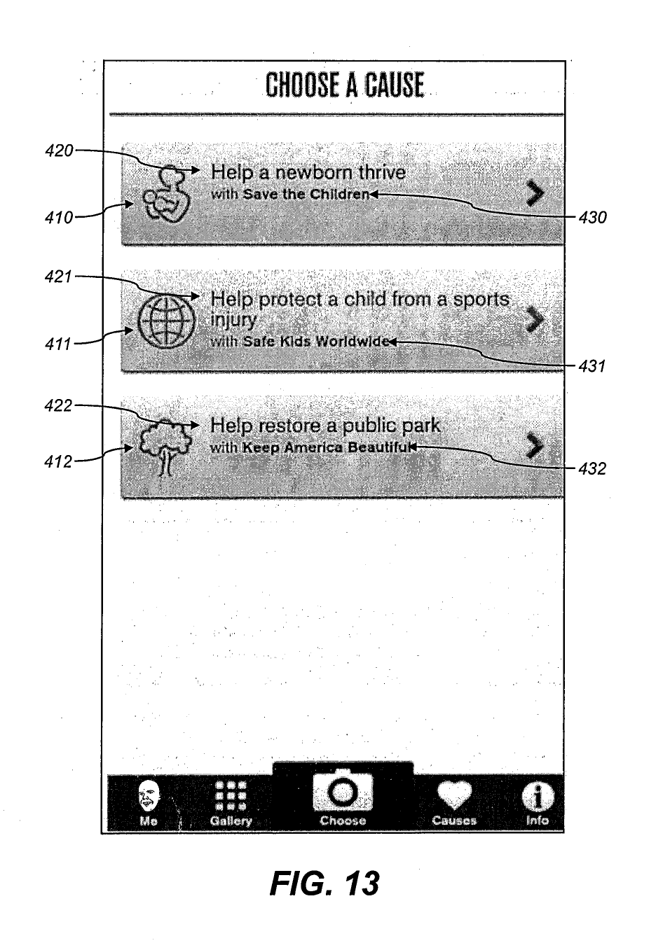

FIG. 7 is a flowchart illustrating exemplary methods for enabling philanthropic donation. In step 2310, a user credential is received from a computer system separate from the processor. The separate system can be, e.g., a system other than the mobile device or terminal of the user. It can be, e.g., a third-party social-networking Web site. User credentials can be OAuth tokens or any other credentials mentioned herein with reference to FIG. 12. User ID and password pairs for third-party systems can also be stored and transmitted, as needed.

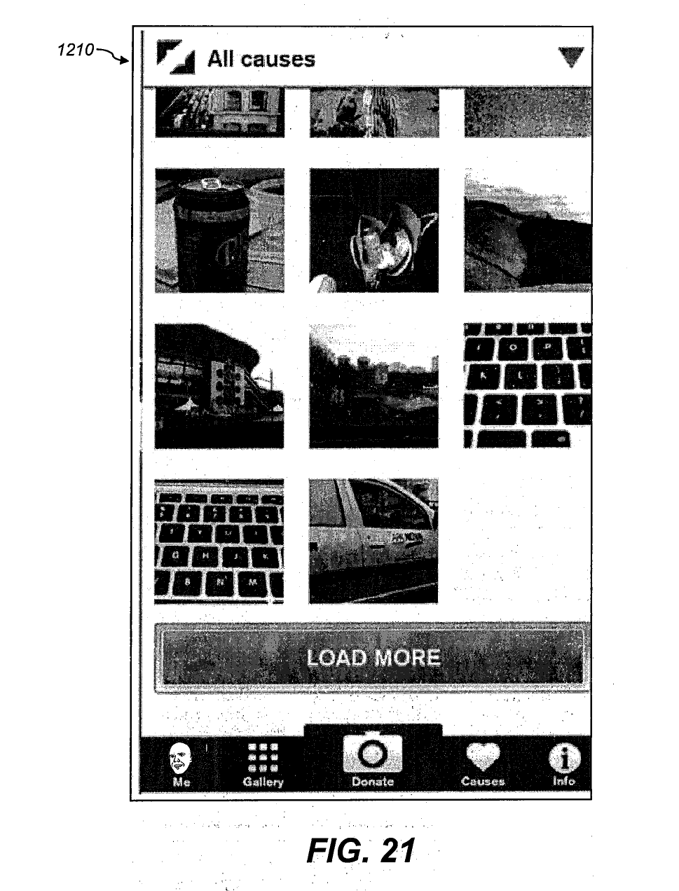

In step 2320, using the processor, a display record is automatically produced. The display record is a data record with contents at least partly intended to be displayed to users or other humans. The display record corresponds to the received item data. An example of a display record is discussed herein with reference to FIG. 20. In other aspects, the terminal can produce the display record and the processor can receive the data record, or the terminal can send the display record to the computer system.

In step 2330, the received user credential and the display record are transmitted to the computer system. In an example, the user credential is a FACEBOOK OAuth token. The display record is a properly-formatted FACEBOOK post. In step 2330, the OAuth token received in step 2310 from FACEBOOK is sent with the display record to FACEBOOK's servers so that the display record will appear as a post on the user's FACEBOOK page. In other aspects, the user's terminal receives the credential, prepares the display record, and transmits the credential and the display record to the computer system. In at least one version, the processor is further configured to enable increased interaction such as for example, identifying “like” friends or profiles using FACEBOOK, TWITTER or those of other web-based social media systems.

In various aspects, the item data includes a digital image. In step 2340, the processor automatically produces the display record including a thumbnail of the digital image. In step 2350, the processor automatically produces the display record including an image caption and at least part of the digital image. The image caption can overlay or be positioned next to the image data. This processing can also be performed by the user's terminal, in various aspects.

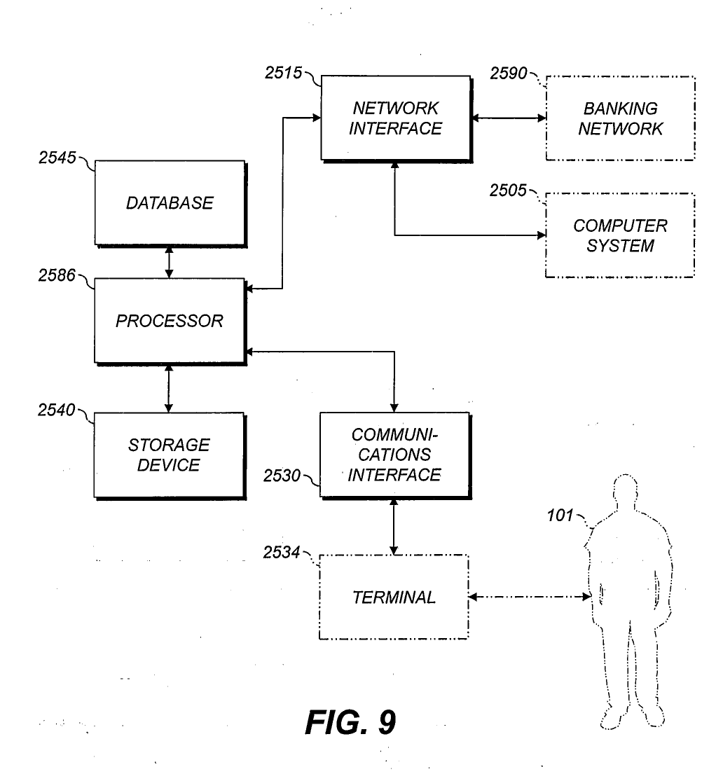

FIG. 8 is a flowchart illustrating exemplary methods for enabling philanthropic donation. References to particular sets of steps throughout the remainder of this disclosure include subsets of the set and combinations of the steps as described above. In step 2405, target-menu data including indications of a plurality of donation targets are provided to a user, or the user's terminal or other device, e.g., as discussed herein with reference to step 2061, FIG. 4. In step 2410, target data are received from the user designating one of the donation targets indicated in the target-menu data, e.g., as discussed herein (step 1910, FIG. 3). In step 2420, item data are received from the user, e.g., via the user's terminal (e.g., as for step 1920, FIG. 3). The item data correspond to a non-monetary item. In step 2430, using a processor, a currency amount of a monetary currency is automatically determined using the received item data (e.g., as for step 1930, FIG. 3). In step 2440, using the processor, a donation record is automatically produced (e.g., as for step 1940, FIG. 3). The donation record indicates that the determined currency amount should be donated as specified by the designated donation target by a donating party different from the user. Donation targets can be as discussed above, FIG. 2, and the method can further including the donating party making the donation in response to the donation record (step 2470; e.g., as discussed herein with reference to step 1970, FIG. 3). The method can include providing to the user an indication of the effect of a donation, as described herein (step 1960, FIG. 3; text 420, 421, 422, FIG. 13), or storing the produced donation record on a non-transitory computer-readable medium.

In various aspects, the providing step 2405 includes transmitting the target-menu data across a communications network. The receiving steps 2410, 2420 include receiving the target data and the item data via the communications network.

In various aspects, category-menu data are provided, a category selection is received, donation-recipient data for the category are retrieved, recipient-menu data are provided, and target data are received. This can be done as described herein with reference to FIG. 3, e.g., steps 1910, 1912, 1913, 1915, 1916, and 1917.

In at least one embodiment, the recipient-menu data includes indications of at least two donation recipients located in different countries. This advantageously provides the user 101 an opportunity to have a positive effect on the lives of people in various parts of the world. In this way, the donating party can achieve a worldwide reach by enabling donations with global effects. The monetary currency can be a local currency of the designated donation recipient, or one of the local currencies if more than one is accepted (e.g., at the time of writing, in Zimbabwe U.S. dollars, U.K. pounds, South African rands, and Botswana pulas circulate; the monetary currency can be any of these for donation recipients in Zimbabwe). As discussed herein with reference to FIG. 3, the user can be anywhere, or can be in a particular area, e.g., a specific country or set of countries.

When using category-menu data, a recipient can also be selected automatically for a given category, e.g., as for steps 1913, 1914, FIG. 3. In various aspects, targets can be removed from a target menu, and optionally new targets (optionally, of the same category as the removed target) added from a list of pending targets, e.g., as discussed herein with reference to FIG. 4 (steps 2001, 2010, 2061, 2031, 2032, 2033, 2037, 2035). Expiry (e.g., step 2050, FIG. 4) and remainder record production (e.g., step 2060, FIG. 4) can also be performed.

In various aspects, record data of stored item-data records can be provided in response to a retrieval command. This can be done as described herein with reference to steps 2210, 2220, 2230, 2240, 2242, and 2250, FIG. 6.

In various aspects, a number of non-monetary items received from the user can be stored and optionally provided to the user. Item-date associations can be recorded, and the donation record can be produced only if the most recent donation was on an earlier day than an attempted donation. Consecutive-date information can be provided to the user. Examples of these are discussed herein with reference to steps 2110, 2132, 2134, 2130, 2140, 2120, and 2125, FIG. 5) (or, as noted above, subsets or combinations of these steps, and likewise throughout).

In various aspects, a user credential can be received for a computer system. A display record can be produced and transmitted with the display record to the computer system. Examples of this are discussed herein with reference to FIG. 7.

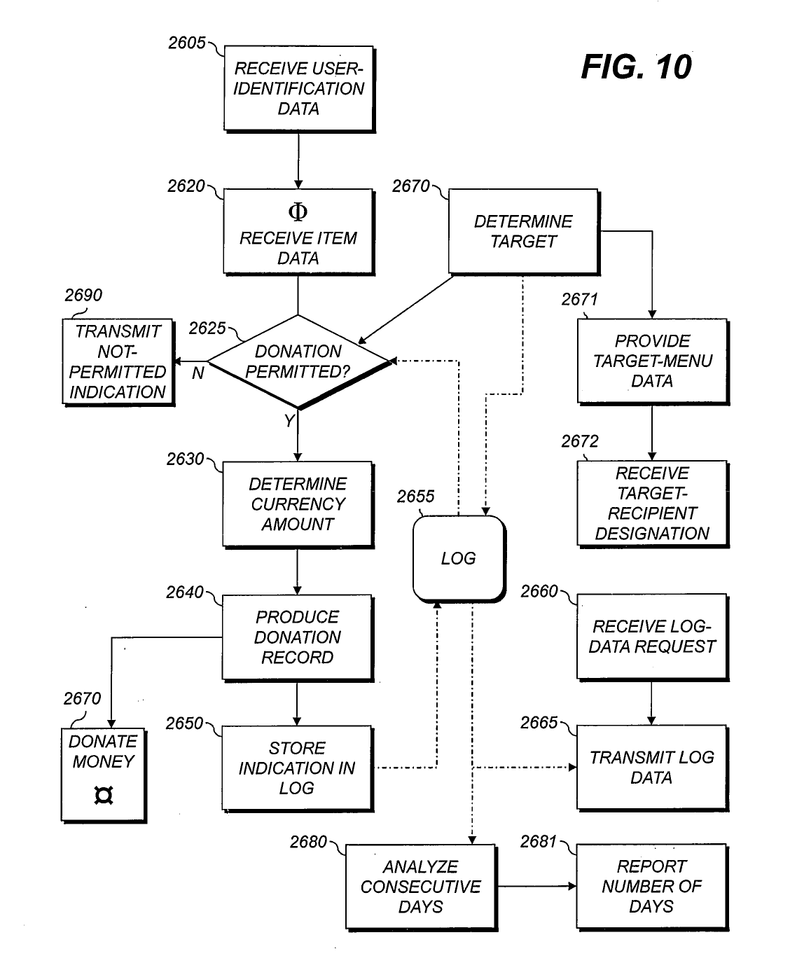

FIG. 9 shows an exemplary system for enabling philanthropic donation and related components (shown in phantom). Storage device 2540 and communications interface 2530 are operatively connected to processor 2586. Processor 2586 can communicate via communications interface 2530 with terminal 2534, through which the processor 2586 communicates with user 101.

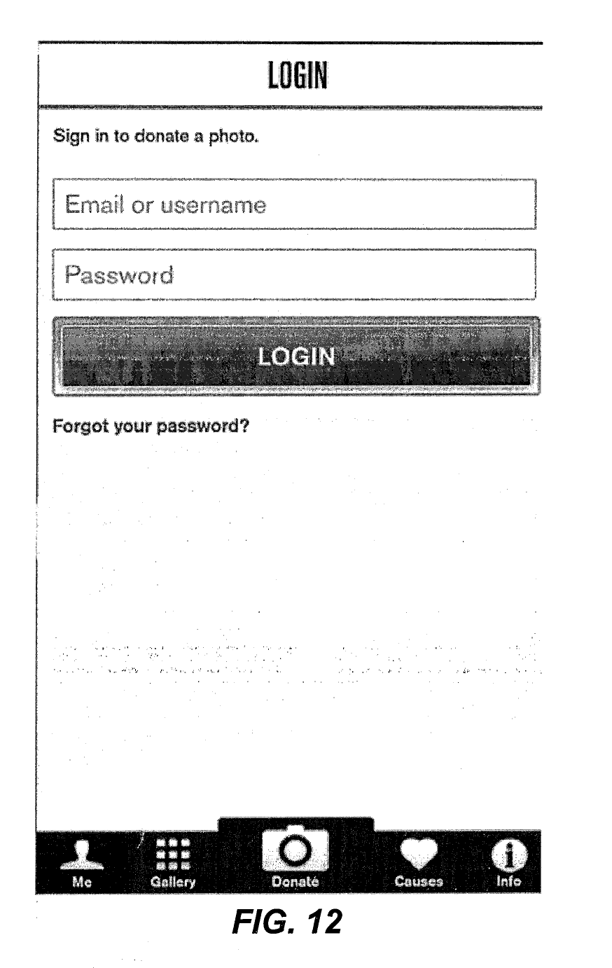

Storage device 2540 can include a data storage system 1840, FIG. 11. The storage device 2540 can include multiple units, e.g., RAID drives, or a combination of, e.g., a hard-disk drive, random-access memory, and Flash memory. The storage device 2540 stores target-menu data including indications of a plurality of donation targets.

The communications interface 2530 can include a user interface system 1830 or network interface 1815, both FIG. 11. The communications interface can include a screen or keyboard and can include multiple communication modes (e.g., a touchscreen for target data and a BLUETOOTH wireless link for item data). The communications interface 2530 can be configured to communicate with a remote server or can be configured as a remote server with which the user's terminal communicates, e.g., via a network interface 1815. The communications interface 2530 is adapted to provide at least some of the target-menu data and to receive several items from a user. The received items include target data designating one of the donation targets indicated in the target-menu data, and item data (e.g., a digital image) corresponding to a non-monetary item. The donation target can be a donation recipient or any other target as discussed above, e.g., with reference to FIG. 2.

The processor 2586 can include a data processing system 1810, FIG. 11. The processor 2586 is adapted to automatically determine a currency amount of a monetary currency using the received item data. The processor 2586 is further adapted to produce a donation record indicating that the determined currency amount should be donated as specified by the designated target by a donating party different from the user. The processor 2586 can store the produced donation record in or using storage device 2540.

In various aspects, the processor 2586 is further adapted to initiate an electronic funds transfer (EFT) such as a wire transfer, debit or credit transaction, or electronic check transaction. The EFT is initiated to transfer the determined currency amount from the donating party to the designated donation recipient. For example, the processor 2586 can be connected via network interface 2515 to a domestic or international banking network 2590, e.g., the Automated Clearing House (ACH) network or the Society for Worldwide Interbank Financial Telecommunication (SWIFT) network. As used herein, the term “banking network” includes any network through which monetary donations can be transferred from the donating party to the designated donation recipient. The processor can initiate the EFT by transmitting an EFT request via network interface 2515 to banking network 2590.

In at least one embodiment, the storage device 2540 further stores category-menu data including indications of a plurality of categories of donation targets. The communications interface 2530 is further adapted to provide the category-menu data and receive from the user category data designating one of the categories indicated in the category-menu data. The processor 2586 is further adapted to automatically select from the stored target-menu data a plurality of the indications of donation targets corresponding to the designated category, so that the communications interface 2530 provides the selected indications as the at least some of the target-menu data. This selection and provision can be done, e.g., as discussed herein with reference to FIG. 3; processor 2586 or communications interface 2530 can be programmed to carry out, e.g., steps 1912, 1913, 1915, 1916, and 1917.

In various aspects, each donation target is a category of recipients. Database 2545, which can be part of storage device 2540 or vice versa, stores associations between donation recipients and categories. The processor 2586 is further adapted to retrieve from the database 2545 a selection of a donation recipient in the designated category and automatically provide a recipient indication of the selected donation recipient in the produced donation record. The donation record thus indicates that the determined currency amount should be donated to the selected donation recipient. Processor 2586 can be programmed to carry out, e.g., steps 1912, 1913, and 1914, FIG. 3.

In various aspects, the storage device 2540 stores respective running sums of determined currency amounts corresponding to each of the designated donation targets, and the processor 2586 is further adapted to remove the indication of one of the donation targets from the target-menu data in response to the running sum corresponding to that target exceeding a selected upper threshold. The storage device 2540 can store a list of donation targets and the processor 2586 can select a replacement target from the list and replace an indication removed from the target-menu data with the selected replacement target. Each donation target can be associated with one of a plurality of categories, and the processor 2586 can select the replacement target from target(s) on the list that correspond to the category of the target removed from the target-menu data. The processor 2586 can store indications of removed donation targets in the storage device 2540. Processor 2586 can be programmed to carry out, e.g., steps 2001, 2010, 2061, 2031, 2032, 2033, 2037, 2035 shown in FIG. 4. Processor 2586 can also be programmed to carry out expiry of targets (e.g., step 2050, FIG. 4) and remainder record production (e.g., step 2060, FIG. 4).

In various aspects, the processor 2586 is further adapted to store received item data in the storage device 2540, to receive requests for stored data via the communications interface 2530, to retrieve one or more stored item-data record(s) from the storage device 2540, and to transmit record data of the retrieved item-data record(s) via the communications interface 2530 in response to the request. The record data can include a digital image. The processor 2586 can be programmed to form a mosaic image using image data of the retrieved item-data record(s) and to transmit image data of the mosaic image. The record data can include a textual message. The record data can include a representation of a mark used in trade. The processor 2586 can be programmed to carry out, e.g., steps 2210, 2220, 2230, 2240, 2242, and 2250, FIG. 6.

In various aspects, the processor 2586 is communicatively connected via the network interface 2515 to computer system 2505, e.g., a social network. The processor 2586 is adapted to receive a user credential via the network interface 2515 from the computer system 2505 separate from the processor 2586. The processor 2586 is adapted to automatically produce a display record corresponding to the received item data and to transmit the received user credential and the display record to the computer system 2505 via the network interface 2515. Processor 2586 can be programmed to carry out, e.g., steps 1920, 2310, 2320, 2330, 2340, and 2350, FIG. 7.

In various examples, the processor 2586 is programmed to carry out methods for enabling philanthropic donation such as those shown in FIGS. 3-8 and 10.

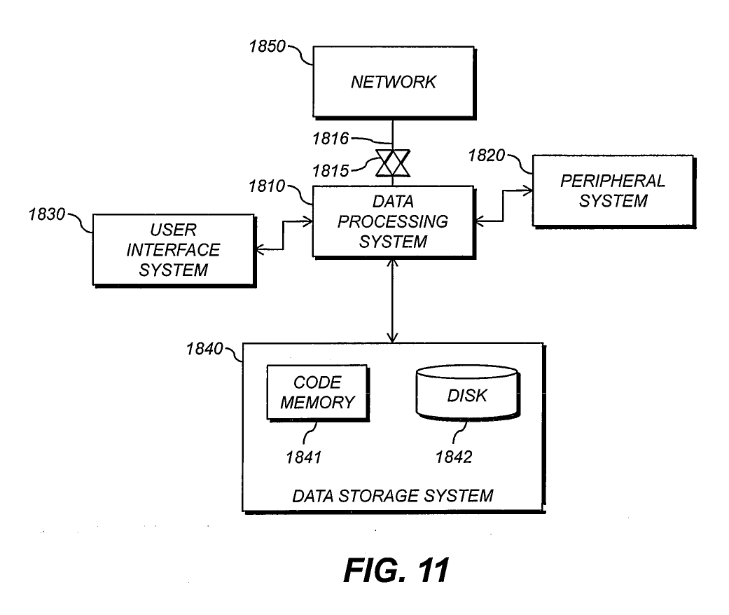

FIG. 10 is a flowchart illustrating exemplary methods for enabling philanthropic donation. Rounded rectangles represent data items and dash-dot arrows represent data flows. In step 2605, user data identifying the user is received, e.g., from the user's terminal. In step 2610, item data corresponding to a non-monetary item is received from the identified user; the receiving can include, e.g., receiving item data as in step 1910, FIG. 3.

In decision step 2625, also referred to herein as a checking step, using a processor, it is automatically determined whether a donation of the non-monetary item is permitted. If so, the next step is step 2630. If not, the next step is step 2690. According to decision step 2625, the processor automatically analyzes a log 2655 associated with the identified user to determine whether the donation is permitted. Log 2655 is discussed below. In addition, the processor analyzes data stored in a log 2655 where that data is associated with the identified user, whether the log 2655 includes data for one user or for a plurality of users. According to the decision step 2625 the processor can determine, for example, whether a user has donated more than a certain number of non-monetary items overall or in a certain length of time, or whether the item data do not meet selected criteria such as minimum or maximum image resolution.

In step 2630, since the donation is permitted, using the processor, a currency amount of a monetary currency is automatically determined using the received item data. In step 2640, a donation record is automatically produced. The donation record indicates that the determined currency amount should be donated by a donating party different from the identified user. These steps can include, e.g., determining amounts and producing records as in steps 1930, 1940, FIG. 3, respectively. In step 2650, an indication that the item data was received is automatically stored in a log 2655 associated with the identified user, as discussed herein.

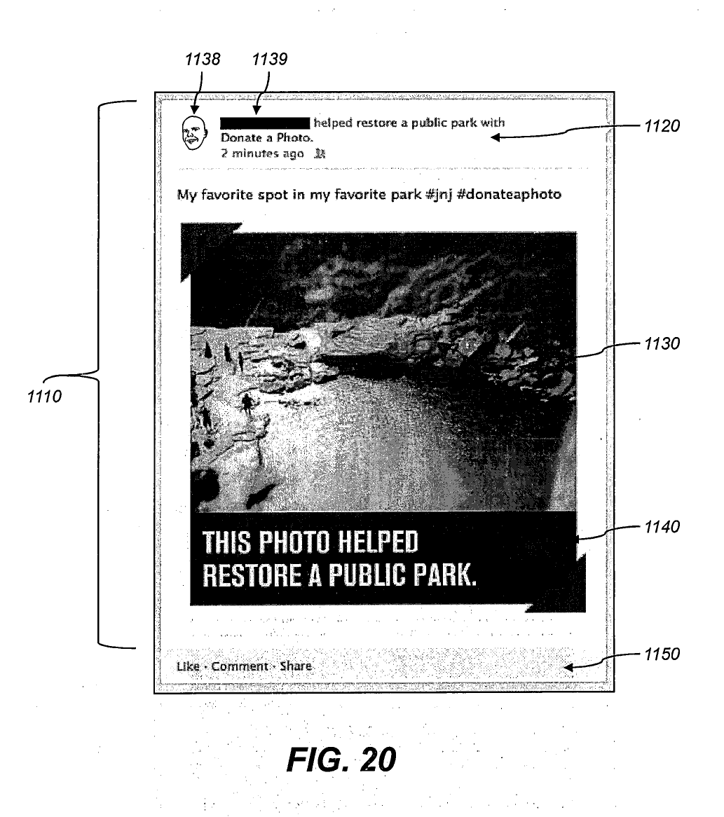

In step 2690, since the donation is not permitted, an indication that the donation is not permitted is automatically transmitted to the identified user. An example of such an indication is shown herein in FIG. 19. The transmitted indication can include information regarding why the donation is not permitted.

Still referring to FIG. 10, the log 2655 updated in step 2650 can include an electronic file or other electronic dataset stored on a storage device or database, e.g., data storage system 1840, FIG. 11) or storage device 2540 or database 2545 (both FIG. 9). The log 265 can also include a paper tape, piano roll, or other non-electronic storage device adapted to be written and read automatically under control of the processor. Each log 2655 can include data corresponding to a respective identified user. Alternatively, user data from several different identified users can be stored in a single dataset, provided each data record is associated with the received user data. For example, the log 2655 for all users can be a single relational-database table with each record containing:
A unique primary key; and
A foreign key into a Users table, where the foreign key is included in the received user data;
   and some or all of:
an indication that item data have been received;
a date of receipt of the item (i.e., of the item data);
some or all of the received item data; and
the determined currency amount.
   In various aspects, step 2650 includes automatically storing some or all of these items in the log 2655 (whether or not the log is a database). These fields can be present in the log 2655 regardless of the form of the log 2655, or whether it is a single-user or multi-user log 2655.

In at least one embodiment, in step 2670, the donating party donates the determined currency amount in response to the donation record (e.g., per step 1970, FIG. 3). In at least one embodiment, the method further includes automatically storing the produced donation record on a non-transitory computer-readable medium (e.g., per step 1950, FIG. 3).

In various aspects, in step 2660, a request for log data is received. In response, in step 2665, at least some of the data stored in the log associated with the identified user are automatically transmitted. In this way, the user can view his or her own log data. An example is shown in FIG. 25. The transmitted data can include date(s) on which one or more non-monetary item(s) were received.

In various aspects, in step 2670, a donation target is determined. In these aspects, producing step 2640 includes providing in the donation record an indication that the amount of money should be donated as specified by the determined donation target. In some of these aspects, and according to the decision step 2625, the processor automatically determines that the donation is permitted only if it is the first donation the identified user has made to the determined donation target on a date of receipt of the item data. The determined donation target can be a non-profit or charitable organization, or another target discussed herein, e.g., with reference to FIG. 2. In various aspects, an indication of the determined donation target is automatically stored in the log 2655, as indicated by the arrow from step 2670 to log 2655.

In various aspects, combinations of these steps can be repeated, e.g., as shown in FIG. 5. For example, steps 2620, 2670, 2625, 2630, 2640, and 2650 can be performed for each of a first non-monetary item and a second non-monetary item. The identified user is thus associated in the log 2655 with the first non-monetary item and the second non-monetary item. In this example, the respective determined donation targets of the first non-monetary item and of the second non-monetary item are different. This repetition advantageously permits the user to support multiple targets with a single account rather than one account per target, and also permits the donating party or other party carrying out the method to enable donations on an ongoing basis, not just for a single target. This approach is sometimes referred to as an “evergreen” approach, because it is not limited to one target.

In various aspects, in step 2680, the log 2655 is automatically analyzed to determine a number of one or more consecutive days on which the identified user has donated a non-monetary item to the determined donation target. The analysis can include retrieving information from the log 2655, sorting the retrieved information, selecting subsets, or other conventional operations for locating sequences in data. In step 2681, the determined number is reported to the identified user via any communications channel or device, e.g., communications interface 2530, FIG. 9. An example of this is shown by text 1610, FIG. 25.

Still referring to FIG. 10, in at least one embodiment, the determining-target step 2670 includes receiving from the identified user category data designating a category of donation targets and, using the processor, automatically retrieving from a database a selection of a recipient in the designated category as the determined donation target. Step 2640 further includes automatically providing a recipient indication of the selected recipient in the produced donation record. In this way, the record indicates that the determined currency amount should be donated to the recipient. This receiving, retrieving, and provision can be done, e.g., as described herein with reference to steps 1913, 1914, and 1950, FIG. 3. In some of these embodiments, category-menu data including indications of a plurality of recipient categories is provided to the identified user. The received category data designates one of the recipient categories indicated in the category-menu data. This can be as per, e.g., steps 1912 and 1913, FIG. 3.

In various aspects, the determining-target step 2670 includes step 2671 of providing target-menu data including indications of a plurality of donation targets. In step 2672, a selection of one of the indications from the target-menu data is received from the identified user. The selection can be stored in the produced donation record or in the log 2655, provided the donation is permitted.

In various of these aspects, the receiving-item-data step 2620, the determining-target step 2670, the checking step 2625, the determining-amount step 2630, and the producing-record step 2640 are repeated for each of a plurality of non-monetary items, each with respective received item data. For each received item, a sum is computed of the determined currency amount(s) indicated in donation record(s) for the determined donation target. If the sum exceeds a selected upper threshold, the indication of that donation target is removed from the target-menu data. This computing, threshold-checking, and removal can be performed, e.g., as discussed herein with reference to steps 2031, 2032, and 2033, FIG. 4. Moreover, a list of pending-target indications can be received, each indicating a donation target, e.g., as in step 2010, FIG. 4. In response to the removal from the target-menu data of the indication for a first one of the target(s) indicated therein, a replacement donation target can be automatically selected, e.g., by a processor, from the targets indicated on the received pending-target indication list. An indication of the selected replacement donation target can be added to the target-menu data. This removal and indication can be as discussed with reference to step 2035, FIG. 4. Each target indication in the target-menu data and the pending-target indication list can indicate a donation recipient associated with one of a plurality of categories, and the selecting-replacement-target step can include automatically selecting the replacement target from the donation target(s) indicated on the received pending-target indication list that are associated with the same category as the first donation target. In response to the removal of one of the targets from the target-menu data, an indication of that target can be stored in a completed-target list stored on a storage device. This storage can be done as discussed with reference to step 2037, FIG. 4.

In various aspects, a user credential is received from a computer system separate from the processor. Using the processor, a display record corresponding to the received item data is automatically produced. The received user credential and the display record are transmitted to the computer system, which can be done, e.g., as discussed with reference to FIG. 7. The item data can include a digital image, and the processor can produce the display record including a thumbnail of the digital image. The processor can also produce the display record including an image caption and at least part of the digital image, e.g., as shown in FIG. 20.

In various aspects, the received item data are stored in an item-data record associated with the designated donation target. Item-data records can be stored in a storage device 2540 or database 2545, FIG. 9. A command to retrieve item data is received, the command including data indicating one or more donation target(s). One or more stored item-data record(s) associated with the indicated donation target(s) are retrieved. Record data of the retrieved item-data record(s) is transmitted. The record data can include a digital image. The transmitting step can include forming a mosaic image using image data of the retrieved item-data record(s) and transmitting image data of the mosaic image. The item data can include a textual message. The record data can include a representation of a mark used in trade. These steps can be performed as described with reference to steps 2210, 2220, 2230, 2240, 2242, FIG. 6.

Still referring to FIG. 10, in various aspects, the storing-item-data step is performed whether or not the donation is permitted. In other aspects, the storing-item-data step is only performed if the donation is permitted. In some aspects, storing-in-log step 2650 step is performed whether or not the donation is permitted. Performing the storing-data and storing-in-log steps whether or not the donation is permitted permits receiving item data and displaying galleries of item data to encourage other users to donate, even if an individual user is limited in the number or frequency of donations.

FIG. 11 is a high-level diagram showing the components of an automated system for analyzing data and performing other analyses described herein. Such an automated system can be part of a donation-enabling system. The automated system includes a data processing system 1810, a peripheral system 1820, a user interface system 1830, and a data storage system 1840. The peripheral system 1820, the user interface system 1830 and the data storage system 1840 are communicatively connected to the data processing system 1810. Data processing system 1810 can be communicatively connected to network 1850, e.g., the Internet or an X.25 network, as discussed below. A donation-enabling system, such as that described herein, can include one or more of systems 1810, 1820, 1830, 1840, and can connect to one or more network(s) 1850.

The data processing system 1810 includes one or more data processor(s) that implement processes of various aspects described herein. As described herein, a “data processor” is a device for automatically operating on data and can include a central processing unit (CPU), a desktop computer, a laptop computer, a mainframe computer, a personal digital assistant, a digital camera, a cellular phone, a smartphone, or any other device for processing data, managing data, or handling data, whether implemented with electrical, magnetic, optical, biological components, or otherwise.

The phrase “communicatively connected” includes any type of connection, wired or wireless, between devices, data processors, or programs in which data can be communicated. Subsystems such as peripheral system 1820, user interface system 1830, and data storage system 1840 are shown separately from the data processing system 1810, but can be stored completely or partially within the data processing system 1810.

The data storage system 1840 includes or is communicatively connected with one or more tangible non-transitory computer-readable storage medium(s) configured to store information, including the information needed to execute processes according to various aspects. A “tangible non-transitory computer-readable storage medium” as used herein refers to any non-transitory device or article of manufacture that participates in storing instructions which may be provided to data processing device 1810 for execution. Such a non-transitory medium can be non-volatile or volatile. Examples of non-volatile media include floppy disks, flexible disks, or other portable computer diskettes, hard disks, punched cards, paper tape, magnetic tape or other magnetic media, Compact Discs and compact-disc read-only memory (CD-ROM), DVDs, BLU-RAY disks, HD-DVD disks, other optical storage media, Flash memories, read-only memories (ROM), and erasable programmable read-only memories (EPROM or EEPROM). Examples of volatile media include dynamic memory, such as registers and random access memories (RAM). Storage media can store data electronically, magnetically, optically, chemically, mechanically, or otherwise, and can include electronic, magnetic, optical, electromagnetic, infrared, or semiconductor components.

Aspects of the present invention can take the form of a computer program product embodied in one or more tangible non-transitory computer readable medium(s) having computer readable program code embodied thereon. Such medium(s) can be manufactured as is conventional for such articles, e.g., by pressing a CD-ROM. The program embodied in the medium(s) includes computer program instructions that can direct data processing system 1810 to perform a particular series of operational steps when loaded, thereby implementing functions or acts specified herein.

In an example, data storage system 1840 includes code memory 1841, e.g., a random-access memory, and disk 1842, e.g., a tangible computer-readable rotational storage device such as a hard drive. Computer program instructions are read into code memory 1841 from disk 1842, or a wireless, wired, optical fiber, or other connection. Data processing system 1810 then executes one or more sequences of the computer program instructions loaded into code memory 1841, as a result performing process steps described herein. In this way, data processing system 1810 carries out a computer implemented process. For example, blocks of the flowchart illustrations or block diagrams herein, and combinations of those, can be implemented by computer program instructions.

Computer program code can be written in any combination of one or more programming languages, e.g., Java, Smalltalk, C++, C, or an appropriate assembly language. Program code to carry out methods described herein can execute entirely on a single data processing system 1810 or on multiple communicatively-connected data processing systems 1810. For example, code can execute wholly or partly on a user's computer and wholly or partly on a remote computer, e.g., a server. The remote computer can be connected to the user's computer through network 1850. The user's computer or the remote computer can be non-portable computers, such as conventional desktop personal computers (PCs), or can be portable computers such as tablets, cellular telephones, smartphones, or laptops.

The peripheral system 1820 can include one or more devices configured to provide digital content records to the data processing system 1810. For example, the peripheral system 1820 can include digital still cameras, digital video cameras, cellular phones, or other data processors. The data processing system 1810, upon receipt of digital content records from a device in the peripheral system 1820, can store such digital content records in the data storage system 1840.

The user interface system 1830 can include a mouse, a keyboard, another computer (connected, e.g., via a network or a null-modem cable), or any device or combination of devices from which data is input to the data processing system 1810. In this regard, although the peripheral system 1820 is shown separately from the user interface system 1830, the peripheral system 1820 can be included as part of the user interface system 1830.

The user interface system 1830 also can include a display device, a processor-accessible memory, or any device or combination of devices to which data is output by the data processing system 1810. In this regard, if the user interface system 1830 includes a processor-accessible memory, such memory can be part of the data storage system 1840 even though the user interface system 1830 and the data storage system 1840 are shown separately in FIG. 11.

In various aspects, data processing system 1810 includes communication interface 1815 that is coupled via network link 1816 to network 1850. For example, communication interface 1815 can be an integrated services digital network (ISDN) card or a modem to provide a data communication connection to a corresponding type of telephone line. As another example, communication interface 1815 can be a network card to provide a data communication connection to a compatible local-area network (LAN), e.g., an Ethernet LAN, or wide-area network (WAN). Wireless links, e.g., WiFi or GSM, can also be used. Communication interface 1815 sends and receives electrical, electromagnetic or optical signals that carry digital data streams representing various types of information across network link 1816 to network 1850. Network link 1816 can be connected to network 1850 via a switch, gateway, hub, router, or other networking device.

Network link 1816 can provide data communication through one or more networks to other data devices. For example, network link 1816 can provide a connection through a local network to a host computer or to data equipment operated by an Internet Service Provider (ISP).

Data processing system 1810 can send messages and receive data, including program code, through network 1850, network link 1816 and communication interface 1815. For example, a server can store requested code for an application program (e.g., a JAVA applet) on a tangible non-volatile computer-readable storage medium to which it is connected. The server can retrieve the code from the medium and transmit it through the Internet, thence a local ISP, thence a local network, thence communication interface 1815. The received code can be executed by data processing system 1810 as it is received, or stored in data storage system 1840 for later execution.

A user terminal can include any of the components described herein. In addition to the examples given herein, a terminal can be any data-communications device, e.g., a desktop or laptop personal computer, an IPAD, a tabletop computer such as a MICROSOFT SURFACE, or any smartphone or tablet computer or similar device.

In view of the disclosure herein, various embodiments of the invention provide donation records indicating currency amounts corresponding to non-monetary donations. A technical effect of various aspects is to allocate actual monetary currency under the control of the donating party in response to provision by a user of the non-monetary item. In various aspects, the donating party provides the allocated money as specified by the designated target, e.g., to a nonprofit organization. This monetary donation can assist the donation target in carrying out its work. By donating a non-monetary item, the user has indicated a desire or intention to support the work of the donation target. Therefore, when the donating party provides the allocated money, it does so in response to the user's desire or intention. This advantageously permits users to support causes they are concerned about and eases the logistical burden on the users of transferring money.

FIGS. 12-26 are representations of screen captures of a mobile app (i.e., a downloadable software application designed to run on mobile devices such as smartphones or tablets) designed to interact with systems for enabling philanthropic donation according to various aspects, and more specifically are representations of exemplary user-interface screens that user 101, FIG. 1, sees while interacting with such a system. The mobile app can run on a tablet, smartphone, or other computing device, all of which are referred to herein as “terminals.” Corresponding applications could also run on conventional desktop personal computers, kiosks, or other computing devices, all of which are also included as “terminals” herein. These figures show examples in which the user 101 donates a photo as a non-monetary item 110, FIG. 1.

FIG. 12 depicts an exemplary login screen. Via this screen, a user 101 provides user data identifying himself or herself to the system. User data can include a username, password, email address, public key, passphrase, secure hash, OAuth token, Kerberos tickets or ticket-granting-tickets, or other identification data, in any combination.

After login to the exemplary app, a “choose a cause” screen such as that shown in FIG. 13 can be presented to the user 101. This screen provides various options that permit the user 101 to select a donation target. In this specific example, three (3) choices of donation targets are identified by category by icons 410, 411, 412. The number of donation targets depicted is exemplary; any number of targets (at least one) can be presented, e.g., in a scrolling list. In each category, in this example, there is exactly one recipient, so choosing a donation target involves choosing a category and a recipient simultaneously. A brief description 420, 421, 422 (“Help . . . ”) is provided for each category, and each organization name 430, 431, 432 is listed.

Using this exemplary mobile app in communication with systems or methods described herein, a user can donate a photo or other non-monetary item, such as a text message. Following selection of a donation target, the dialog of FIG. 14 is presented. This dialog relates to donations of photos and permits user 101 to specify whether to use an existing picture stored on the user's terminal or to take a picture with a camera attached or built in to the terminal.

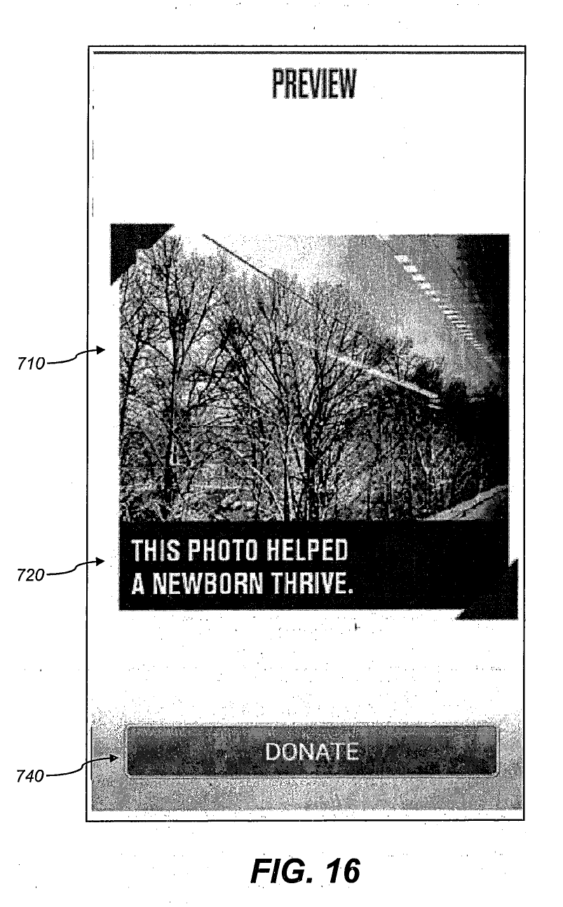

In the present application example, the user may elect to only utilize a portion of selected photograph for purposes of donation. To that end, FIG. 15 shows a screen permitting the user 101, once the user has selected a photo, to choose an area of the photo. This example shows selection of a rectangular area, but other area shapes can be used.

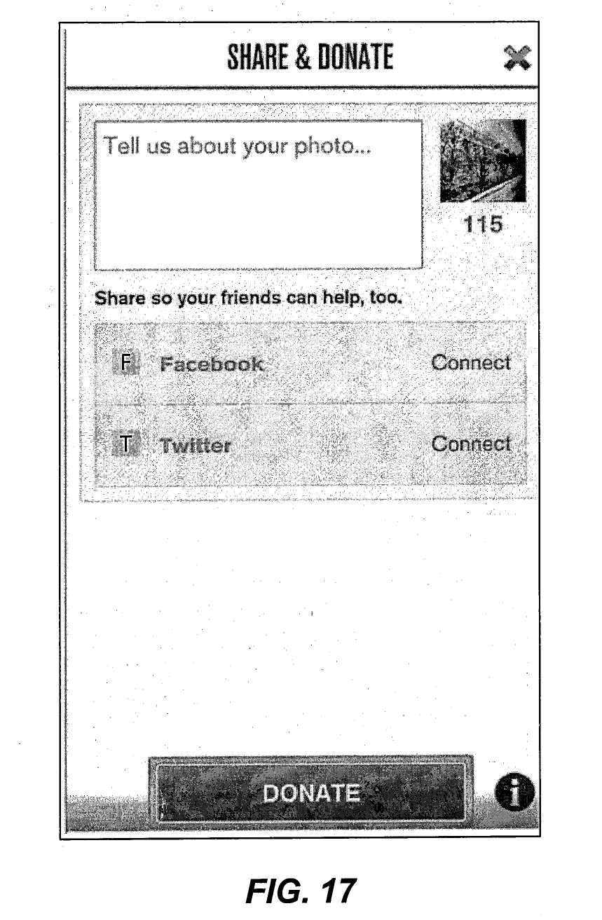

Once the non-monetary item (e.g., photo) has been selected, and according to this example, a visual representation of item data corresponding to a non-monetary item is displayed, such as that shown on the screen represented in FIG. 16. In this example, the non-monetary item includes a photo 710. An image caption 720 indicating the effect of making a donation to a recipient in the selected category is further displayed. A sponsor's logo can optionally be displayed, e.g., below the photo 710. “Donate” button 740 begins a process of sending the item data to a server or other computing device in the donation-enabling system.

Upon donation of the above data, the herein described mobile application or other interface permits the user 101 to provide information used to produce a display record including the donated photo and an optional message, e.g., as shown in FIG. 17. The display record can then be transmitted to a computer system, e.g., a social-networking Web site such as FACEBOOK or INSTAGRAM or a blogging or micro-blogging Web site such as TWITTER.

FIG. 18 shows a screen confirming that the user 101 has donated the photo. The screen also includes an indication 910 of the number of consecutive dates on which the donation-enabling system has received a donation of a photo from the identified user. This advantageously encourages the user 101 to continue donating.

FIG. 19 shows a screen that can be provided by the donation-enabling system in aspects that determine whether a donation is permitted. In this example, a donation is permitted only if it is the first donation the identified user has made to the selected donation target on a date of receipt of the item data. Message 1010 informs the user 101 that only a single donation per day is permitted, and encourages user 101 to make another donation the following day. In various aspects, message 1010 points out to the user 101 that additional donations permit the user 101 to “keep helping the causes you care about.” This can encourage the user 101 by providing an increased sense that the user 101 has control over the effect of his or her donations.

FIG. 20 shows a screen presenting a exemplary display record 1110. The display record 1110 is designed to be viewed by people other than user 101 via an interface to a computer system such as FACEBOOK, INSTAGRAM and TWITTER, through functionality that is provided within the application interface. Avatar 1138 represents the user 101. The user's name 1139 is represented here by a solid rectangle, and likewise throughout. Text 1120 indicates that the user 101 made a non-monetary donation. The display record 1110 also includes a digital image 1130 of the donated photo 710, FIG. 16) or a thumbnail thereof and an image caption 1140. In this example, footer 1150, including “Like,” “Comment,” and “Share” links, is added by the computer system. Using these links, for example, users can identify “like” friends by virtue of the causes and charitable items selected and permit increased opportunities for connectivity through FACEBOOK and similar social media systems using the herein described application. An exemplary display screen providing this functionality is depicted in FIG. 25(b). For non-open source programs, such as INSTAGRAM, the user interface can provide a connective link to the website such as in the display screen presented following the donation of a photo using the herein described application. In various aspects, similar footers or links can be added by the donation-enabling system.

FIG. 21 shows a screen presenting a grid view of a gallery of thumbnails of donated non-monetary items, in this example photos. The donation-enabling system stores donated item data in item-data records. In response to a command to retrieve item data, the system transmits record data of item-data records to the terminal of user 101. Selector 1210 permits the user 101 to select one or more donation target(s), as discussed herein with reference to FIG. 24.

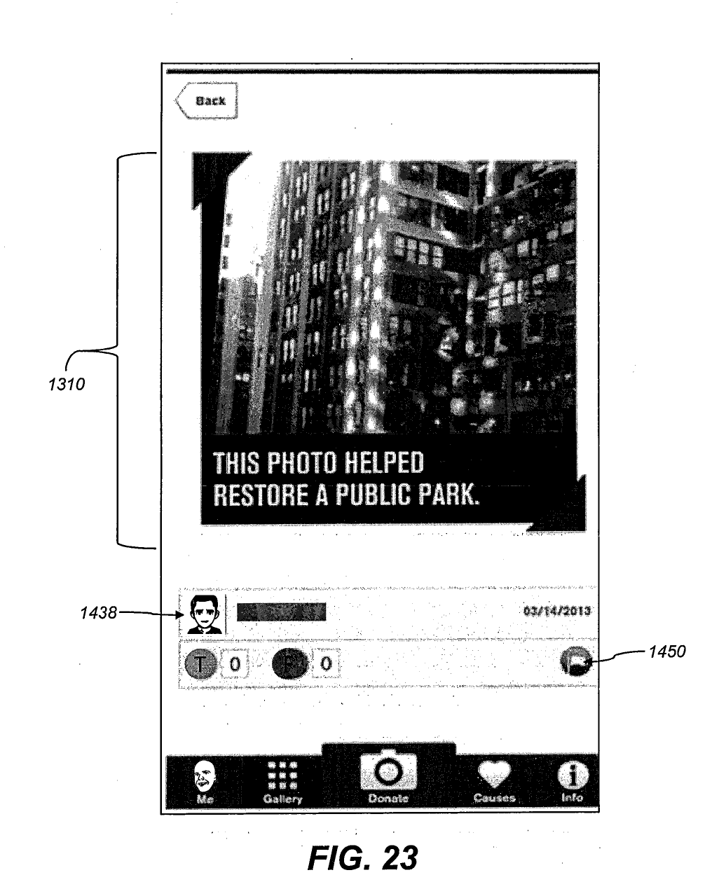

FIG. 22 shows a screen presenting a list or “details” view of the item-data gallery. Record data 1310, 1320 are for respective photos (record data 1320 are only partly-visible; more data can be shown by scrolling). According to at least one version, item (photo) data from other “like” users can also be presented and scrolled, such as through interconnection to various social media websites.

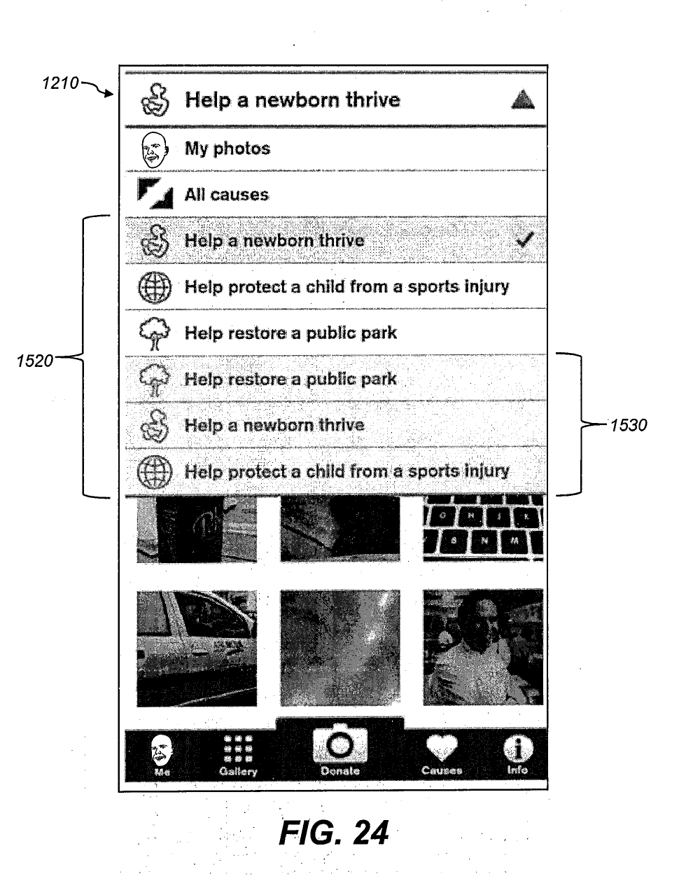

FIG. 23 shows a screen presenting a detailed view of record data 1310. Avatar 1438 represents the user who donated the non-monetary item represented in record data 1310. Moderation icon 1450 permits a viewer of such a screen to indicate that record data 1310 should be evaluated for compliance with standards of decency or other selected standards.

FIG. 24 shows an exemplary display screen with selector 1210 activated to show a list 1520 of donation target(s). When a target is selected, only record data associated with the selected donation target(s) will be displayed. This filtering can be performed on the user's terminal or on the donation-enabling system. In this example, list 1520 includes data from completed-target list 1530. As discussed herein, the donation-enabling system may limit donations to specific donation targets. Once the limit has been reached, the system can move that donation target to a completed-target list. Record data for the targets on the completed-target list can still be retrieved. In this example, the donation targets on completed-target list 1530 were in the same categories as still-active targets on list 1520. Selector 1210 also has an “All causes” entry to show record data without regard to its association with a particular donation target.

FIG. 25 shows a screen presenting log information about the user 101. The donation-enabling system can store log information about the user 101, e.g., number of non-monetary donations made, dates of donations, item data, or currency amounts 140, FIG. 1. Text 1610 indicates the number of consecutive date(s) on which the system received item data of non-monetary item(s) from the user 101. Text 1620 indicates the total number of non-monetary item(s) received from user 101, and the time range between the first and last receipt. Record data 1630 show record data of item data donated by user 101, the record data grouped by donation target. FIG. 25(b) presents another exemplary display screen (e.g., a user profile page) illustrating how certain functionalities such as prior use and summary of non-monetary contributions, number of causes contributed to by the user, and other relevant information, including the most recent donated photo and linkages permitting interaction via social media (e.g., FACEBOOK, TWITTER). This page further permits various user account settings to be adjusted, as needed.

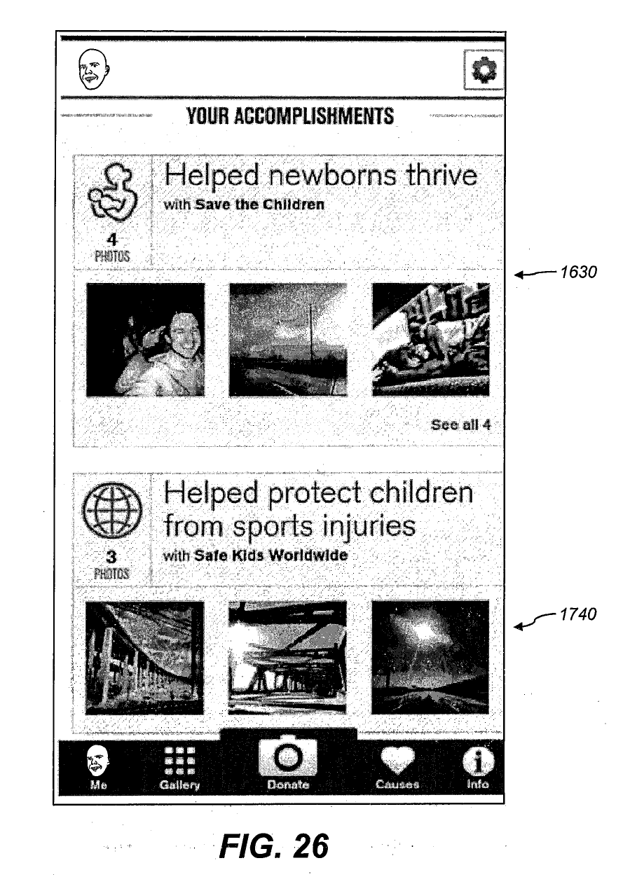

FIG. 26 shows an exemplary screen presenting record data 1630, 1740 for donations to respective donation targets (here, organizations) by the identified user 101.

Various aspects of donation-enabling methods and systems described herein permit the functions described herein with reference to FIGS. 12-26 to be carried out. For example, without limitation, such methods and systems can receive user-identifying information, receive item data, produce display records, provide item data, provide record data, provide log data, communicate with the user's terminal via a network or other communications channel, or store information required to carry out these functions on volatile or nonvolatile tangible storage media.

The invention is inclusive of combinations of the aspects described herein. References to “a particular aspect” and the like refer to features that are present in at least one aspect of the invention. Separate references to “an aspect” or “particular aspects” (or “embodiments” or “variants” or “examples”) or the like do not necessarily refer to the same aspect or aspects; however, such aspects are not mutually exclusive, unless so indicated or as are readily apparent to one of skill in the art. The use of singular or plural in referring to “method” or “methods” and the like is not limiting. The word “or” is used in this disclosure in a non-exclusive sense, unless otherwise explicitly noted.

The invention has been described in detail with particular reference to certain preferred aspects thereof, but it will be understood that variations, combinations, and modifications can be effected by a person of ordinary skill in the art within the spirit and scope of the invention. Examples of variations, combinations, and modifications that are intended to be within the scope of the claims are those having structural elements that do not differ from the literal language of the claims and those including equivalent structural elements with insubstantial differences from the literal language of the claims

1. A method of enabling philanthropic donation, the method comprising:
receiving from a user target data designating a donation target;
receiving from the user item data corresponding to a non-monetary item;
using a processor, automatically determining a currency amount of a monetary currency using the received item data; and
using the processor, automatically producing a donation record indicating that the determined currency amount should be donated as specified by the designated donation target by a donating party different from the user.

2. The method according to claim 1, further including automatically storing the produced donation record on a non-transitory computer-readable medium, wherein the produced donation record includes data indicating the determined currency amount and data indicating the designated donation target.

3. The method according to claim 1, wherein the receiving-designation step includes receiving the designation from a mobile device and the receiving-item-data step includes receiving the item data from a mobile device.

4. The method according to claim 1, wherein the donation target is at least one of a non-profit or charitable organization and a particular campaign of an organization.

5. The method according to claim 4, wherein the campaign or organization specifies an effect of donating the non-monetary item, the method further including providing to the user an indication of the effect.

6. The method according to claim 1, further including:
storing the received item data in an item-data record associated with the designated donation target;
receiving a command to retrieve item data, the command including data indicating one or more donation target(s);
retrieving one or more stored item-data record(s) associated with the indicated donation target(s); and
transmitting record data of the retrieved item-data record(s).

7. The method according to claim 1, wherein the receiving-designation step includes providing recipient-menu data including indications of a plurality of donation recipients, wherein the received target data designates as the donation target one of the donation recipients indicated in the recipient-menu data.

8. The method according to claim 1, wherein the receiving-designation step includes:
receiving the target data designating a category of donation recipients;
using the processor, automatically retrieving from a database a selection of a donation recipient in the designated category; and
automatically providing a recipient indication of the selected donation recipient in the produced donation record, whereby the record indicates that the determined currency amount should be donated to the selected donation recipient.

9. The method according to claim 9, wherein the receiving-designation step includes providing to the user category-menu data including indications of a plurality of recipient categories and receiving the target data designating one of the recipient categories indicated in the category-menu data as the donation recipient.

10. The method according to claim 1, wherein the receiving-designation step includes:
providing to the user category-menu data including indications of a plurality of recipient categories;
receiving from the user category data designating one of the recipient categories indicated in the category-menu data;
using the processor, automatically retrieving from a database respective recipient data for a plurality of donation recipients corresponding to the designated category;
using the retrieved recipient data, providing to the user recipient-menu data including indications of the plurality of donation recipients; and
receiving the target data designating one of the donation recipients indicated in the recipient-menu data as the donation target.

11. The method according to claim 1, further including:
receiving, from a computer system separate from the processor, a user credential;
using the processor, automatically producing a display record corresponding to the received item data; and
transmitting the received user credential and the display record to the computer system.

12. The method according to claim 1, further including:
repeating the receiving-designation, receiving-item-data, determining, and producing steps for each of a plurality of non-monetary items, each with respective received item data; and
for each received item:
determining a sum of the determined currency amount(s) indicated in the produced donation record(s) for the designated donation target; and
if the sum exceeds a selected upper threshold, recording a ceiling indication that the designated donation target is no longer open for donations.

13. The method according to claim 12, further including:
retrieving target-menu data from a storage device, the target-menu data including indications of a plurality of donation targets; and
receiving a list of pending-target indications, each indicating a donation target;
wherein the receiving-target step includes providing the target-menu data to the user and receiving from the user the target data designating one of the targets indicated in the target-menu data; and
further including, in response to the ceiling indication's being recorded for a first one of the target(s) indicated in the target-menu data, removing the indication of that target from the target-menu data, automatically selecting a replacement target from the targets indicated on the received pending-target indication list, and adding an indication of the selected replacement target to the target-menu data.

14. The method according to claim 1, wherein the item data is at least one of a digital image and a textual message and the donating party is a corporation.

15. The method according to claim 1, further including the step of transmitting the display record, including the item data, to other computer systems, including social media systems.

16. A system for enabling philanthropic donation, comprising:
a) a storage device storing target-menu data including indications of a plurality of donation targets;
b) a communications interface adapted to provide at least some of the target-menu data and to receive from a user:
i) target data designating one of the targets indicated in the target-menu data, and
ii) item data corresponding to a non-monetary item; and
c) a processor adapted to automatically:
i) determine a currency amount of a monetary currency using the received item data; and
ii) produce a donation record indicating that the determined currency amount should be donated as specified by the designated target by a donating party different from the user.

17. The system according to claim 16, wherein the processor is further adapted to store the produced donation record using the storage device.

18. The system according to claim 16, wherein each donation target is a donation recipient and the donation record indicates that the determined currency amount should be donated to the designated donation recipient.

19. The system according to claim 18, wherein at least one of the donation recipients is a non-profit or charitable organization.

20. The system according to claim 16, wherein:
the storage device further stores category-menu data including indications of a plurality of categories of targets;
the communications interface is further adapted to provide the category-menu data and receive from the user category data designating one of the categories indicated in the category-menu data; and
the processor is further adapted to automatically select from the stored target-menu data a plurality of the indications of donation targets corresponding to the designated category, so that the communications interface provides the selected indications as the at least some of the target-menu data.

21. The system according to claim 17, wherein:
each donation target is a category of recipients;
the system further includes a database that stores associations between donation recipients and categories; and
the processor is further adapted to retrieve from the database a selection of a donation recipient in the designated category and automatically provide a recipient indication of the selected donation recipient in the produced donation record, whereby the record indicates that the determined currency amount should be donated to the selected donation recipient.

22. The system according to claim 16, wherein the storage device stores respective running sums of determined currency amounts corresponding to each of the designated donation targets, and the processor is further adapted to remove the indication of one of the donation targets from the target-menu data in response to the running sum corresponding to that target exceeding a selected upper threshold.

23. The system according to claim 16, wherein the processor is further adapted to store received item data in the storage device, to receive requests for stored data via the communications interface, to retrieve one or more stored item-data record(s) from the storage device, and to transmit record data of the retrieved item-data record(s) via the communications interface in response to the request.

24. The system according to claim 16, further including a network interface, wherein the processor is adapted to:
receive via the network interface, from a computer system separate from the processor, a user credential;
automatically produce a display record corresponding to the received item data; and
transmit the received user credential and the display record to the computer system via the network interface.

25. The system according to claim 24, wherein the system is configured to transmit the display record, including the item data, to other computer systems, including social media systems.
